(19) United States
(12) Patent Application Publication
(10) Pub. No.: US 2021/0012263 A1
(43) Pub. Date: Jan. 14, 2021

(54) Computer System and Method of Evaluating Fuel Efficiency of Assets Using a Predictive Model

(71) Applicant: Uptake Technologies, Inc., Chicago, IL (US)

(72) Inventors: Weiyu Max Li, Chicago, IL (US); Stephanie Kirmer, Chicago, IL (US); Brian Silva, Chicago, IL (US)

(21) Appl. No.: 16/505,416

(22) Filed: Jul. 8, 2019

(51) Int. Cl. G06Q 10/06; G07C 5/02; G06N 5/02

(52) U.S. Cl. CPC G06Q 10/06393; G06N 5/02; G07C 5/02

(57) ABSTRACT

A computing system may define a predictive model that is configured to receive, for a given set of data variables, data values that are related to operation of an asset during an observation period, and based on the received data values, output a prediction of fuel consumption of the asset during the observation period, where the given set of data variables may include data variables from different categories of data variables. The computing system may then obtain a dataset that includes, for the given set of data variables, data values that are related to operation of a given asset during a given observation period, apply the predictive model to the obtained dataset, and perform an evaluation of whether any data variable in the given set of data variables presented a fuel savings opportunity for the given asset during the given observation period.

### BACKGROUND

Today, machines (also referred to herein as “assets”) are ubiquitous in many industries. From locomotives that transfer cargo across countries to farming equipment that harvest crops, assets play an important role in everyday life. Depending on the role that an asset serves, its complexity, and cost, may vary.

Because of the increasing role that assets play, it is also becoming increasingly desirable to monitor and analyze the operation of assets in a given operating environment over a given duration of time. In particular, it may be desirable to monitor and analyze the operation of assets to help reduce an asset owner's operating expenses and thus increase the asset owner's overall profit.

### OVERVIEW

One significant category of expense incurred by an asset owner is the cost of fuel needed for the owner's assets to operate. As such, improving fuel efficiency is often of great interest to asset owners. Indeed, if an asset owner can find ways for assets to consume less fuel while performing their intended tasks, this allows the asset owner to save on fuel costs and thus increases the asset owner's overall profit.

However, existing technology for evaluating and identifying ways to improve fuel efficiency of an asset has several limitations. For instance, one existing approach for evaluating the fuel efficiency of an asset involves tracking certain operator events (e.g., idling, excessive breaking, speeding, etc.) that are believed to have a negative impact on aspects of asset operation, which may include fuel consumption, and then outputting an “operator score” to represent the operator's performance. However, because this operator score is based specifically on operator events, it fails to account for various other categories of data variables that impact an asset's fuel consumption, which may include data related to an asset's configuration (e.g., asset type make, model, etc.) and/or data related to a given operating environment (e.g., weather, road conditions etc.), among other examples. Moreover, this operator score does not provide any indication of how much fuel is predicted to be consumed at an asset during a given observation period, what the most impactful ways are to increase the asset's fuel efficiency, or how much fuel savings can be achieved at an asset.

Another existing approach for evaluating the fuel efficiency of an asset involves making recommendations for improving fuel efficiency of an asset that are based on subject matter expert (SME) input regarding the apparent correlation between certain asset operating variables and fuel consumption at an asset. However, as with the operator score, these recommendations fail to account for various other categories of data variables that impact an asset's fuel consumption. Moreover, because these recommendations are based on SME input as opposed to actual data, they tend to provide more generic guidance that does have a sufficient level of accuracy, reliability, or precision from asset to asset.

In view of the foregoing, there is a need for technology that can provide a data-driven prediction of how much fuel will be consumed by an asset during a given observation period and what the most likely causes of fuel inefficiency are at the asset, which can then be used to identify the most impactful ways to increase an asset's fuel efficiency.

To help address these and other problems, the present disclosure is directed to a new predictive model for predicting an asset's fuel consumption based on several different categories of variables (referred to herein at times as a “fuel consumption model”), as well as an associated method for using the disclosed predictive model to evaluate the fuel efficiency of various different assets during various different observation periods and thereby identify the most likely causes for fuel inefficiency and/or the most impactful ways to improve fuel efficiency at the asset—which provides a direct financial benefit to an asset owner. In general, the disclosed predictive model may be defined and deployed by any computing system that has access to data described herein and has sufficient computing capability to perform data analytics operations, where such a computing system may generally be referred to herein as a “data analytics platform.”

At a high level, the disclosed predictive model may be configured to predict a given asset's fuel consumption during a given observation period (e.g., a particular window of time, a particular trip taken by the asset, etc.) based on at least two of the following categories of data inputs related to the operation of the given asset during the given observation period: (1) “asset-specific data,” which generally comprises data related to the configuration and/or physical condition of the given asset during the given observation period, (2) “operator-specific data,” which generally comprises data related to the individual that operated the given asset (e.g., the asset's driver) during the given observation period, and (3) “environmental data,” which generally comprises data related to the environment in which the given asset was operating during the given observation period. The predictive model's input variables from each of these categories may take various forms as described in more detail herein.

Upon receiving data inputs from the above categories for a given asset during a given observation period, the disclosed predictive model may output a prediction of the given asset's fuel consumption during a given observation period. This output may take various forms as described in more detail herein.

Further, in practice, the disclosed predictive model may be defined in various manners, which may generally begin with the data analytics platform obtaining a set of training data for use in training the disclosed predicted model and applying a machine learning technique to the obtained set of training data, among other possibilities.

After the disclosed predictive model has been defined, the data analytics platform may then use the predictive model to carry out a process for evaluating the fuel efficiency of various different assets during various different observation periods. According to an example embodiment, after deciding to evaluate the fuel efficiency of a given asset during a given observation period using the disclosed predictive model, the data analytics platform may obtain a dataset that includes data values associated with the given asset and the given observation period for the disclosed predictive model's set of input data variables (e.g., data values for asset-specific, operator-specific, and/or environmental data variables). In turn, the data analytics platform may apply the disclosed predictive model to the obtained dataset in order to predict the given asset's expected fuel consumption during the given observation period (i.e., the fuel consumption of the given asset during the given observation period that would be expected under the circumstances reflected by the dataset that is input into the predictive model).

After determining the expected fuel consumption of the given asset during the given observation period, the data analytics platform may then perform an evaluation of whether any data variable in the predictive model's set of input variables presented a fuel savings opportunity for the given asset during the given observation period. This evaluation may take various forms.

According to one possible implementation, the evaluation of whether any data variable in the predictive model's set of input variables presented a fuel savings opportunity for the given asset during the given observation period may take the form of an iterative process that iterates through each respective data variable of at least a subset of the predictive model's set of input variables, and for each such data variable, the evaluation may involve (1) adjusting the value of the respective data variable from its original value to a predetermined value that is intended to represent a “normal” value for the respective data variable (while keeping the values for all other data variables the same) and thereby creating a modified dataset; (2) re-applying the disclosed predictive model to the modified dataset comprising the adjusted value of the representative data variable and thereby predicting a hypothetical fuel consumption of the given asset during the given observation period (i.e., the fuel consumption of the given asset during the given observation period that would be expected under the hypothetical circumstances reflected by the modified dataset that is input into the predictive model); (3) performing a comparison between the expected fuel consumption of the given asset during the given observation period and the hypothetical fuel consumption of the given asset during the given observation period; and (4) based on the comparison, determining whether the respective data variable presented a fuel savings opportunity for the given asset during the given observation period.

However, the evaluation of whether any data variable in the predictive model's set of input variables presented a fuel savings opportunity for the given asset during the given observation period may take other forms as well.

Based on the foregoing evaluation, the data analytics platform may identify one or more data variables that presented a fuel savings opportunity for the given asset during the given observation period. In turn, the data analytics platform store a “fuel savings opportunity dataset” related to the operation of the given asset during the observation period, where such a fuel savings opportunity dataset may include an indication of the identified one or more data variables that presented the fuel savings opportunity and perhaps also a corresponding amount of fuel savings that is presented for each of the identified one or more data variables.

In accordance with the present disclosure, the disclosed process described above may be repeated to derive fuel savings opportunity datasets for various different assets during various different observations periods. Further, after the disclosed process has been repeated for various different assets during various different observations periods, a data analytics platform may roll up the resulting fuel savings opportunity datasets in various manners.

Further, the rolled up fuel savings opportunity datasets may be used to help a user (e.g., an asset owner and/or operator) visualize fuel savings opportunities. In this respect, a data analytics platform may be configured to provide a graphical user interface (“GUI”) through which the rolled-up fuel savings opportunity datasets may be presented, and this GUI may take various forms.

Once the rolled-up fuel savings opportunity datasets have been provided to a user, the user may then be able to create a tailored action plan for how to best improve the fuel efficiency of its assets, which may involve addressing certain aspects of assets in a given fleet that are believed to have a negative impact on aspects of asset operation and/or coaching individual operators of the assets in a given fleet to address certain aspects of operator performance that are believed to have a negative impact on the fuel efficiency of an asset.

Based on the foregoing, it will be appreciated that the disclosed process for evaluating the fuel efficiency of various different assets during various different observation periods may provide several advantages over existing approaches for evaluating asset-related fuel efficiency. For example, because the disclosed predictive model accounts for multiple different categories of data variables that have an impact of an asset's fuel consumption, this may enable the disclosed predictive model to render a more accurate prediction of an asset's fuel consumption during a given observation period, which may in turn provide a more accurate assessment of the fuel savings opportunities that may be presented.

As another example, because the disclosed process for evaluating fuel efficiency uses the disclosed predictive model, which as noted above accounts for various categories of data variables that impact an asset's fuel consumption, this may enable the disclosed process to evaluate and identify a wider range of possible opportunities for achieving fuel savings, which may in turn improve an asset owner's ability to reduce costs associated with the fuel consumption of its assets.

As yet another example, the disclosed process for evaluating fuel efficiency is capable of quantifying the different fuel savings opportunities that may be available in terms of how much fuel consumption can be reduced and/or how much can be saved in fuel costs, which may provide actionable guidance to asset owners than other existing approaches for evaluating fuel efficiency.

As described herein, the disclosed predictive model and associated process gives rise to other advantages as well.

Accordingly, in one aspect, disclosed herein is a method that involves (a) defining a predictive model that is configured to (i) receive, for a given set of data variables, data values that are related to operation of an asset during an observation period, and (ii) based on the received data values, output a prediction of fuel consumption of the asset during the observation period, wherein the given set of data variables includes data variables from at least two different categories of data variables selected from a group consisting of an asset-specific data variable category, an operator-specific data variable category, and an environmental data variable category, (b) obtaining a dataset that includes, for the given set of data variables, data values that are related to operation of a given asset during a given observation period, (c) applying the predictive model to the obtained dataset and thereby predict an expected fuel consumption of the given asset during the given observation period, (d) performing an evaluation of whether any data variable in the given set of data variables presented a fuel savings opportunity for the given asset during the given observation period, wherein the evaluation comprises, for each respective data variable in at least a subset of the given set of data variables: (i) modifying the dataset to include, for the respective data variable, a different data value that is associated with normal operation; (ii) re-applying the predictive model to the modified dataset and thereby predicting a hypothetical fuel consumption of the given asset during the given observation period; (iii) performing a comparison between the expected fuel consumption of the given asset during the given observation period and the hypothetical fuel consumption of the given asset during the given observation period; and (iv) based on the comparison, determining whether the respective data variable presented a fuel savings opportunity for the given asset during the given observation period, and (e) based on the evaluation, identifying one or more data variables that presented a fuel savings opportunity for the given asset during the given observation period.

In another aspect, disclosed herein is a computing system that includes a network interface, at least one processor, a non-transitory computer-readable medium, and program instructions stored on the non-transitory computer-readable medium that are executable by the at least one processor to cause the computing system to carry out the functions disclosed herein, including but not limited to the functions of the foregoing method.

In yet another aspect, disclosed herein is a non-transitory computer-readable storage medium provisioned with software that is executable to cause a computing system to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts a simplified block diagram of an example asset data platform from a structural perspective.

FIG. 3 depicts a simplified block diagram of an example asset data platform from a functional perspective.

FIG. 4 depicts a simplified block diagram of the on-board components of an example asset.

FIG. 5 depicts a simplified block diagram of an example local analytics device.

FIG. 6. depicts a flow diagram showing some example operations that may be included in the process for deploying the disclosed predictive model.

FIG. 7 depicts a flow diagram showing some example operations that may be included in the iterative process for identifying one or more data variables that presented a fuel savings opportunity.

FIG. 8 depicts an example fleet-level view that may be presented to a user.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. EXAMPLE NETWORK CONFIGURATION

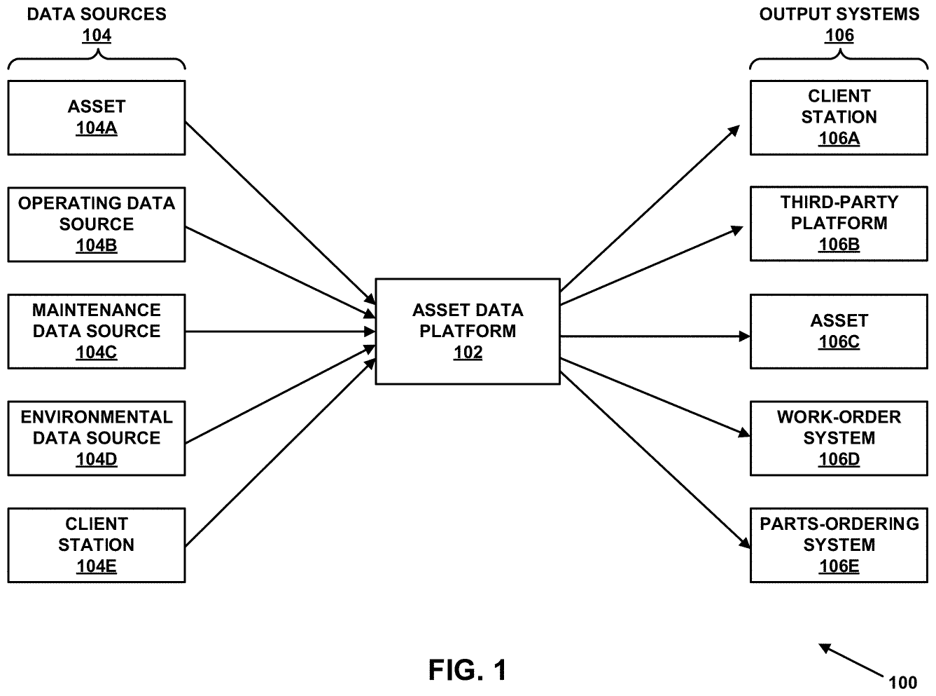

Turning now to the figures, FIG. 1 depicts an example network configuration 100 in which example embodiments may be implemented. As shown, network configuration 100 includes at its core a central computing system 102, which may be communicatively coupled to one or more data sources 104 and one or more output systems 106 via respective communication paths. In such an arrangement, central computing system 102 may generally serve as an “asset data platform” that is configured to perform functions to facilitate the monitoring, analysis, and/or management of various types of “assets,” which may take various forms.

For instance, some representative types of assets that may be monitored by asset data platform 102 may include transport vehicles (e.g., locomotives, aircrafts, passenger vehicles, trucks, ships, etc.), equipment for construction, mining, farming, or the like (e.g., excavators, bulldozers, dump trucks, earth movers, etc.), manufacturing equipment (e.g., robotics devices, conveyor systems, and/or other assembly-line machines), electric power generation equipment (e.g., wind turbines, gas turbines, coal boilers), petroleum production equipment (e.g., gas compressors, distillation columns, pipelines), and data network nodes (e.g., personal computers, routers, bridges, gateways, switches, etc.), among other examples. Additionally, an asset may have various other characteristics that more specifically define the type of asset, examples of which may include the asset's brand, make, model, vintage, and/or software version, among other possibilities. In this respect, depending on the implementation, the assets monitored by asset data platform 102 may either be of the same type or various different types. Additionally yet, the assets monitored by asset data platform 102 may be arranged into one or more “fleets” of assets, which refers to any group or two or more assets that are related to one another in some manner (regardless of whether such assets are of the same type).

Broadly speaking, asset data platform 102 may comprise one or more computing systems that have been provisioned with software for carrying out one or more of the platform functions disclosed herein, including but not limited to receiving data related to the operation and/or management of assets (broadly referred to herein as “asset-related data”) from data sources 104, performing data ingestion and/or data analytics operations on the asset-related data received from asset data sources 104, and then outputting data and/or instructions related to the operation and/or management of assets to output systems 106. The one or more computing systems of asset data platform 102 may take various forms and be arranged in various manners.

For instance, as one possibility, asset data platform 102 may comprise computing infrastructure of a public, private, and/or hybrid cloud (e.g., computing and/or storage clusters) that has been provisioned with software for carrying out one or more of the platform functions disclosed herein. In this respect, the entity that owns and operates asset data platform 102 may either supply its own cloud infrastructure or may obtain the cloud infrastructure from a third-party provider of “on demand” computing resources, such include Amazon Web Services (AWS), Microsoft Azure, Google Cloud, Alibaba Cloud, or the like. As another possibility, asset data platform 102 may comprise one or more dedicated servers that have been provisioned with software for carrying out one or more of the platform functions disclosed herein. Other implementations of asset data platform 102 are possible as well.

Further, in practice, the software for carrying out the disclosed platform functions may take various forms. As one possibility, the platform software may comprise executable program instructions that cause asset data platform 102 to perform data ingestion operations on asset-related data received from data sources 104, including but not limited to extraction, transformation, and loading operations, among other examples. As another possibility, the platform software may comprise executable program instructions that cause asset data platform 102 to perform data analytics operations based on the asset-related data received from data sources 104, including but not limited to failure prediction, anomaly detection, fuel management, noise filtering, image analysis, predictive recommendations, and label correction, among other examples. As yet another possibility, the platform software may comprise executable program instructions that cause asset data platform 102 to output data and/or instructions related to the operation and/or management of assets for receipt by one or more output systems 106.

As one specific example, the platform software may comprise executable program instructions for outputting data related to the operation and/or management of assets that is to be presented to a user (e.g., asset-related data received from data sources 104 and/or the results of the data analytics operations performed by asset data platform 102), and these program instructions may take the form of discrete “applications” that are each tailored for particular end users, particular groups of assets, and/or particular purposes. Some representative examples of such applications may include an asset performance management application, an asset fleet management application, a service optimization application, and an asset dealer operations application, among other possibilities.

The software for carrying out the disclosed platform functions may take various other forms as well.

As described above, asset data platform 102 may be configured to receive asset-related data from one or more data sources 104. These data sources—and the asset-related data output by such data sources—may take various forms. To illustrate, FIG. 1 shows some representative examples of data sources 104 that may provide asset-related data to asset data platform 102, which are discussed in further detail below. However, it should be understood that these example data sources are merely provided for purposes of illustration, and that asset data platform 102 may be configured to receive asset-related data from other types of data sources as well.

For instance, one type of data source 104 may take the form of an asset 104A, which may be equipped with components that are configured to capture data that is indicative of the operation of the asset—referred to herein as “operating data”—and then transmit the asset's operating data to asset data platform 102 over the respective communication path between asset 104A and asset data platform 102. In this respect, asset 104A may take any of the various forms described above, including but not limited to a transport vehicle, heavy equipment, manufacturing equipment, electric power generation equipment, and/or petroleum production equipment, among other types of assets. Further, it should be understood that the components of asset 104A for capturing and transmitting the asset's operating data either may be included as part of asset 104A as manufactured or may be affixed to asset 104A at some later date, among other possibilities.

The operating data that is captured and sent by asset 104A may take various forms. As one possibility, an asset's operating data may include sensor data that comprises time-series measurements for certain operating parameters of the asset, examples of which may include speed, velocity, acceleration, location, weight, temperature, pressure, friction, vibration, power usage, throttle position, fluid usage, fluid level, voltage, current, magnetic field, electric field, presence or absence of objects, current position of a component, and power generation, among many others. As another possibility, an asset's operating data may include abnormal-conditions data that indicates occurrences of discrete abnormal conditions at the asset, examples of which include fault codes that indicate the occurrence of certain faults at the asset (e.g., when an operating parameter exceeds a threshold), asset shutdown indicators, and/or other types of abnormal-condition indicators. As yet another possibility, an asset's operating data may include data that has been derived from the asset's sensor data and/or abnormal-conditions data, examples of which may include “roll-up” data (e.g., an average, mean, median, etc. of the raw measurements for an operating parameter over a given time window) and “features” data (e.g., data values that are derived based on the raw measurements of two or more of the asset's operating parameters). An asset's operating data may take various other forms as well.

In practice, an asset's operating data may also include or be associated with data that identifies the origin of the operating data. This origin data may take various forms. For example, such origin data may include identifying information for the originating asset (e.g., an asset ID and/or data indicating the asset's type, brand, make, model, age, software version, etc.) and/or identifying information for the component of asset 104A that captured the operating data (e.g., a sensor ID), among other possibilities. As another example, such origin data may include data indicating the time at which the operating data was captured (e.g., a timestamp) and/or the asset's location when the operating data was captured (e.g., GPS coordinates), to the extent that such location is not otherwise included in the operating data. Asset data platform 102 may receive other types of data from asset 104A as well.

Further, asset data platform 102 may be configured to receive operating data from asset 104A in various manners. As one possibility, asset 104A may be configured to send its operating data to asset data platform 102 in a batch fashion, in which case asset data platform 102 may receive periodic transmissions of operating data from asset 104A (e.g., on an hourly, daily, or weekly basis). As another possibility, asset data platform 102 may receive operating data from asset 104A in a streaming fashion as such operating data is captured by asset 104A. As yet another possibility, asset data platform 102 may receive operating data from asset 104A in response to sending a request for such data to asset 104A, in which case asset data platform 102 may be configured to periodically send requests for operating data to asset 104A. Asset data platform 102 may be configured to receive operating data from asset 104A in other manners as well.

Another type of data source 104 may take the form of operating data source 104B, which may comprise a computing system that is configured to receive operating data from one or more upstream sources of operating data (e.g., assets) and then provide this operating data to asset data platform 102 over the respective communication path between operating data source 104B and asset data platform 102. Such an operating data source may take various forms. As one possibility, operating data source 104B may comprise an existing data platform of a third-party organization that receives and/or maintains operating data for one or more assets, such as a data platform operated by an asset owner, an asset dealer, an asset manufacturer, an asset repair shop, or the like. As another possibility, operating data source 104B may comprise an intermediary system that compiles operating data from a plurality of upstream sources of operating data and then provides that compiled operating data to asset data platform 102. For example, such an intermediary system may take the form of a computing system located in proximity to a fleet of assets (e.g., at a job site or wind farm) that is configured to compile operating data for the fleet of assets or a computing system that is configured to compile operating data maintained by several third-party data platforms, among other possibilities. Operating data source 104B may take other forms as well.

The operating data that is maintained and sent by operating data source 104B may take various forms, including but not limited to any of the forms described above. In addition to the operating data received from the one or more upstream sources, the operating data provided by operating data source 104B may also include additional operating data that is generated by operating data source 104B itself, such as operating data that operating data sources 104B derives based on the operating data received from the one or more upstream sources (e.g., abnormal-conditions data, roll-up data, features data, etc.).

Further, as with asset 104A, asset data platform 102 may be configured to receive operating data from operating data source 104B in various manners. As one possibility, operating data source 104B may be configured to send its operating data to asset data platform 102 in a batch fashion, in which case asset data platform 102 may receive periodic transmissions of operating data from operating data source 104B (e.g., on an hourly, daily, or weekly basis). As another possibility, asset data platform 102 may receive operating data from operating data source 104B in a streaming fashion as such operating data is received and/or otherwise generated by operating data source 104B. As yet another possibility, asset data platform 102 may receive operating data from operating data source 104B in response to sending a request for such data to operating data source 104B, in which case asset data platform 102 may be configured to periodically send requests for operating data to operating data source 104B. As still another possibility, asset data platform 102 may receive operating data from operating data source 104B by accessing an Application Programming Interface (API) that has been made available by operating data source 104B, subscribing to a service provided by operating data source 104B, or the like. Asset data platform 102 may be configured to receive operating data from operating data source 104B in other manners as well.

Yet another type of data source 104 may take the form of an asset maintenance data source 104C, which may comprise a computing system that is configured to generate and/or receive data related to the maintenance of a plurality of assets—referred to herein as “maintenance data”—and then send this maintenance data to asset data platform 102 over the respective communication path between asset maintenance data source 104C and asset data platform 102. In this respect, asset maintenance data source 104C may take various forms. As one possibility, asset maintenance data source 104C may comprise an existing data platform of a third-party organization that is interested in tracking the maintenance of assets, such as an asset owner, asset dealer, asset manufacturer, asset repair shop, or the like. As another possibility, asset maintenance data source 104C may comprise an intermediary system that compiles asset maintenance data from multiple upstream sources (e.g., multiple repair shops) and then provides that compiled maintenance data to asset data platform 102. Asset maintenance data source 104C may take other forms as well.

The asset maintenance data that is maintained and sent by asset maintenance data source 104C may take various forms. As one example, the asset maintenance data may include details regarding inspections, maintenance, servicing, and/or repairs that have been performed or are scheduled to be performed on assets (e.g., work order data). As another example, the asset maintenance data may include details regarding known occurrences of failures at assets (e.g., date of failure occurrence, type of failure occurrence, etc.). Other examples are possible as well. As with the operating data, the asset maintenance data may also include or be associated with data indicating the origins of the asset maintenance data (e.g., source identifier, timestamp, etc.).

Further, asset data platform 102 may be configured to receive operating data from asset maintenance data source 104C in various manners, including but not limited to any of the manners discussed above with respect to operating data source 104B.

Still another type of data source 104 may take the form of environmental data source 104D, which may comprise a computing system that is configured to generate and/or receive data about an environment in which assets operate—referred to herein as “environmental data”—and then send this data to asset data platform 102 over the respective communication path between environmental data source 104D and asset data platform 102. In this respect, environmental data source 104D—and the environmental data provided thereby—may take various forms.

As one possibility, environmental data source 104D may take the form of a weather data source that provides information regarding the weather at locations where assets operate (e.g., ambient temperature, air pressure, humidity, wind direction, wind speed, etc.). As another possibility, environmental data source 104D may take the form of a geospatial data source that provides information regarding the geography and/or topology at locations where assets operate. As yet another possibility, environmental data source 104D may take the form of a satellite image data source that provides satellite imagery for locations where assets operate. As still another possibility, environmental data source 104D may take the form of a traffic data source that provides information regarding ground, air, and/or water traffic at locations where assets operate. Environmental data source 104D may take other forms as well.

Further, in practice, asset data platform 102 may be configured to receive operating data from asset environmental data source 104D in various manners, including but not limited to any of the manners discussed above with respect to operating data source 104B.

Another type of data source 104 may take the form of client station 104E, which may comprise any computing device that is configured to receive user input related to the operation and/or management of assets (e.g., information entered by a fleet operator, a repair technician, or the like) and then send that user input to asset data platform 102 over the respective communication path between client station 104E and asset data platform 102. In this respect, client station 104E may take any of various forms, examples of which may include a desktop computer, a laptop, a netbook, a tablet, a smartphone, and/or a personal digital assistant (PDA), among other possibilities.

The user input that is entered into client station 104E and sent to asset data platform 102 may comprise various different kinds of information, including but not limited to the kinds of information discussed above with respect to the other data sources. For instance, as one possibility, the user input may include certain kinds of operating data, maintenance data, and/or environmental data that may be input into asset data platform 102 by a user rather than being received from one of the aforementioned data sources. As another possibility, the user input may include certain user-defined settings or logic that is to be used by asset data platform 102 when performing data ingestion and/or data analytics operations. The user input that is entered into client station 104E and sent to asset data platform 102 may take various other forms as well.

The aforementioned data sources 104 are merely provided for purposes of illustration, and it should be understood that the asset data platform's data sources may take various other forms as well. For instance, while FIG. 1 shows several different types of data sources 104, it should be understood that asset data platform 102 need not be configured to receive asset-related data from all of these different types of data sources, and in fact, asset data platform 102 could be configured to receive asset-related data from as little as a single data source 104. Further, while data sources 104A-E have been shown and described separately, it should be understood that these data sources may be combined together as part of the same physical computing system (e.g., an organization's existing data platform may serve as both operating data source 104B and maintenance data source 104C). Further yet, it should be understood that asset data platform 102 may be configured to receive other types of data related to the operation and/or management of assets as well, examples of which may include asset management data (e.g., route schedules and/or operational plans), enterprise data (e.g., point-of-sale (POS) data, customer relationship management (CRM) data, enterprise resource planning (ERP) data, etc.), and/or financial markets data, among other possibilities.

As shown in FIG. 1, asset data platform 102 may also be configured to output asset-related data and/or instructions for receipt by one or more output systems 106. These output systems—and the data and/or instructions provided to such output systems—may take various forms. To illustrate, FIG. 1 shows some representative examples of output systems 106 that may receive asset-related data and/or instructions from asset data platform 102, which are discussed in further detail below. However, it should be understood that these example output systems are merely provided for purposes of illustration, and that asset data platform 102 may be configured to output asset-related data and/or instructions to other types of output systems as well.

For instance, one type of output system 106 may take the form of client station 106A, which may comprise any computing device that is configured to receive asset-related data from asset data platform 102 over the respective communication path between client station 106A and asset data platform 102 and then present such data to a user (e.g., via a front-end application that is defined by asset data platform 102). In this respect, client station 106A may take any of various forms, examples of which may include a desktop computer, a laptop, a netbook, a tablet, a smartphone, and/or a PDA, among other possibilities. Further, it should be understood that client station 106A could either be a different device than client station 104E or could be the same device as client station 104E.

The asset-related data that is output for receipt by client station 106A may take various forms. As one example, this asset-related data may include a restructured version of asset-related data that was received by asset data platform 102 from one or more data sources 104 (e.g., operating data, maintenance data, etc.). As another example, this asset-related data may include data that is generated by asset data platform 102 based on the asset-related data received from data sources 104, such as data resulting from the data analytics operations performed by asset data platform 102 (e.g., predicted failures, recommendations, alerts, etc.). Other examples are possible as well.

Along with the asset-related data that is output for receipt by client station 106A, asset data platform 102 may also output associated data and/or instructions that define the visual appearance of a front-end application (e.g., a graphical user interface (GUI)) through which the asset-related data is to be presented on client station 106A. Such data and/or instructions for defining the visual appearance of a front-end application may take various forms, examples of which may include Hypertext Markup Language (HTML), Cascading Style Sheets (CSS), and/or JavaScript, among other possibilities. However, depending on the circumstance, it is also possible that asset data platform 102 may output asset-related data to client station 106A without any associated data and/or instructions for defining the visual appearance of a front-end application.

Further, client station 106A may receive asset-related data from asset data platform 102 in various manners. As one possibility, client station 106A may send a request to asset data platform 102 for certain asset-related data and/or a certain front-end application, and client station 106A may then receive asset-related data in response to such a request. As another possibility, asset data platform 102 may be configured to “push” certain types of asset-related data to client station 106A, such as scheduled or event-based alerts, in which case client station 106A may receive asset-related data from asset data platform 102 in this manner. As yet another possibility, asset data platform 102 may be configured to make certain types of asset-related data available via an API, a service, or the like, in which case client station 106A may receive asset-related data from asset data platform 102 by accessing such an API or subscribing to such a service. Client station 106A may receive asset-related data from asset data platform 102 in other manners as well.

Another type of output system 106 may take the form of a data platform 106B operated by a third-party organization that interested in the operation and/or management of assets, such as an asset owner, an asset dealer, an asset manufacturer, an asset repair shop, or the like. For instance, a third-party organization such as this may have its own data platform 106B that already enables users to access and/or interact with asset-related data through front-end applications that have been created by the third-party organization, but data platform 106B may not be programmed with the capability to ingest certain types of asset-related data or perform certain types of data analytics operations. In such a scenario, asset data platform 102 may be configured to output certain asset-related data for receipt by data platform 106B.

The asset-related data that is output for receipt by data platform 106B may take various forms, including but not limited any of the forms described above in connection with the output to client station 106A. However, unlike for client station 104A, the asset-related data that is output for receipt by data platform 106B typically need not include any associated data and/or instructions for defining the visual appearance of a front-end application, because data platform 106B may be performing operations on the asset-related data from asset data platform 102 beyond presenting it to a user via a front-end application.

Further, data platform 106B may receive asset-related data from asset data platform 102 in various manners, including but not limited to any of the manners discussed above with respect to client station 106A (e.g., by sending a request to asset data platform 102, having data “pushed” by asset data platform, or accessing an API or service provided by asset data platform 102).

Yet another type of output system 106 may take the form of asset 106C, which may be equipped with components that are configured to receive asset-related data and/or instructions from asset data platform 102 and then act in accordance with the received data and/or instructions. In this respect, asset 106C may take any of the various forms described above, including but not limited to a transport vehicle, heavy equipment, manufacturing equipment, electric power generation equipment, and/or petroleum production equipment, among other types of assets. Further, it should be understood that asset 106C could either be a different asset than asset 104A or could be the same asset as asset 104A.

The asset-related data and/or instructions that are output for receipt by asset 106C may take various forms. As one example, asset data platform 102 may be configured to send asset 106C certain data that has been generated by asset data platform 102 based on the asset-related data received from data sources 104, such as data resulting from a data analytics operation performed by asset data platform 102 (e.g., predicted failures, recommendations, alerts, etc.), in which case asset 106C may receive this data and then potentially adjust its operation in some way based on the received data. As another example, asset data platform 102 may be configured to generate and send an instruction for asset 106C to adjust its operation in some way (e.g., based on the asset-related data received from data sources 104), in which case asset 106C may receive this instruction and then potentially adjust its operation in accordance with the instruction. As yet another example, asset data platform 102 may be configured to generate and send an instruction for asset 106C to perform a data analytics operation locally at asset 106C, in which case asset 106C may receive the instruction and then locally perform the data analytics operation. In some cases, in conjunction with sending asset 106C an instruction to perform a data analytics operation, asset data platform 102 may also provide asset 106C with executable program instructions and/or program data that enable asset 106C to perform the data analytics operation (e.g., a predictive model). However, in other cases, asset 106C may already be provisioned with executable program instructions for performing the data analytics operation. Other examples are possible as well.

Further, in practice, asset 106C may receive asset-related data and/or instructions from asset data platform 102 in various manners, including but not limited to any of the manners discussed above with respect to client station 106A.

Still another type of output system 106 may take the form of work-order system 106D, which may comprise a computing system that is configured to receive asset-related data and/or instructions from asset data platform 102 over the respective communication path between work-order system 106D and asset data platform 102 and then generate a work order in accordance with the received data and/or instructions.

A further type of output system 106 may take the form of parts-ordering system 106E, which may comprise a computing system that is configured to receive asset-related data and/or instructions from asset data platform 102 over the respective communication path between parts-ordering system 106E and asset data platform 102 and then generate a parts order in accordance with the received data and/or instructions.

The aforementioned output systems 106 are merely provided for purposes of illustration, and it should be understood that output systems in communication with asset data platform 102 may take various other forms as well. For instance, while FIG. 1 shows several different types of output systems 106, it should be understood that asset data platform 102 need not be configured to output asset-related data and/or instructions for receipt by all of these different types of output systems, and in fact, asset data platform 102 could be configured to asset-related data and/or instructions for receipt by as little as a single output system 106. Further, while output systems 106A-E have been shown and described separately, it should be understood that these output systems may be combined together as part of the same physical computing system. Further yet, it should be understood that asset data platform 102 may be configured to output asset-related data and/or instructions for receipt by other types of output systems as well.

As discussed above, asset data platform 102 may communicate with the one or more data sources 104 and one or more output systems 106 over respective communication paths. Each of these communication paths may generally comprise one or more communication networks and/or communications links, which may take any of various forms. For instance, each respective communication path with asset data platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path with asset data platform 102 may be wireless, wired, or some combination thereof, and may carry data according to any of various different communication protocols.

Although not shown, the respective communication paths with asset data platform 102 may also include one or more intermediate systems. For example, it is possible that a given data source 104 may send asset-related data to one or more intermediary systems, such as an aggregation system, and asset data platform 102 may then be configured to receive the asset-related data from the one or more intermediary systems. As another example, it is possible that asset data platform 102 may communicate with a given output system 106 via one or more intermediary systems, such as a host server (not shown). Many other configurations are also possible.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. EXAMPLE PLATFORM

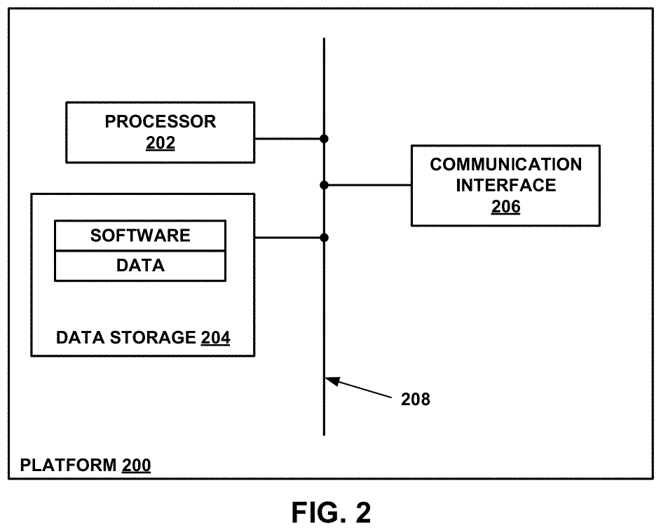

FIG. 2 is a simplified block diagram illustrating some structural components that may be included in an example computing platform 200, which could serve as the asset data platform 102 in FIG. 1. In line with the discussion above, platform 200 may generally comprise one or more computer systems (e.g., one or more servers), and these one or more computer systems may collectively include at least a processor 202, data storage 204, and a communication interface 206, all of which may be communicatively linked by a communication link 208 that may take the form of a system bus, a communication network such as a public, private, or hybrid cloud, or some other connection mechanism.

Processor 202 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 202 could comprise processing components that are distributed across a plurality of physical computing devices connected via a network, such as a computing cluster of a public, private, or hybrid cloud.

In turn, data storage 204 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 204 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 2, data storage 204 may be provisioned with software components that enable the platform 200 to carry out the functions disclosed herein. These software components may generally take the form of program instructions that are executable by the processor 202 to carry out the disclosed functions, which may be arranged together into software applications, virtual machines, software development kits, toolsets, or the like.

Further, data storage 204 may be arranged to store asset-related data in one or more databases, file systems, or the like. For example, data storage 204 may be configured to store data using technologies such Apache Cassandra, Apache Hadoop, PostgreSQL, and/or MongoDB, among other possibilities. Data storage 204 may take other forms and/or store data in other manners as well.

Communication interface 206 may be configured to facilitate wireless and/or wired communication with data sources and output systems, such as data sources 104 and output systems 106 in FIG. 1. Additionally, in an implementation where platform 200 comprises a plurality of physical computing devices connected via a network, communication interface 206 may be configured to facilitate wireless and/or wired communication between these physical computing devices (e.g., between computing and storage clusters in a cloud network). As such, communication interface 206 may take any suitable form for carrying out these functions, examples of which may include an Ethernet interface, a serial bus interface (e.g., Firewire, USB 2.0, etc.), a chipset and antenna adapted to facilitate wireless communication, and/or any other interface that provides for wireless and/or wired communication. Communication interface 206 may also include multiple communication interfaces of different types. Other configurations are possible as well.

Although not shown, platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with platform 200.

It should be understood that platform 200 is one example of a computing platform that may be used with the embodiments described herein. Numerous other arrangements are possible and contemplated herein. For instance, other computing platforms may include additional components not pictured and/or more or less of the pictured components.

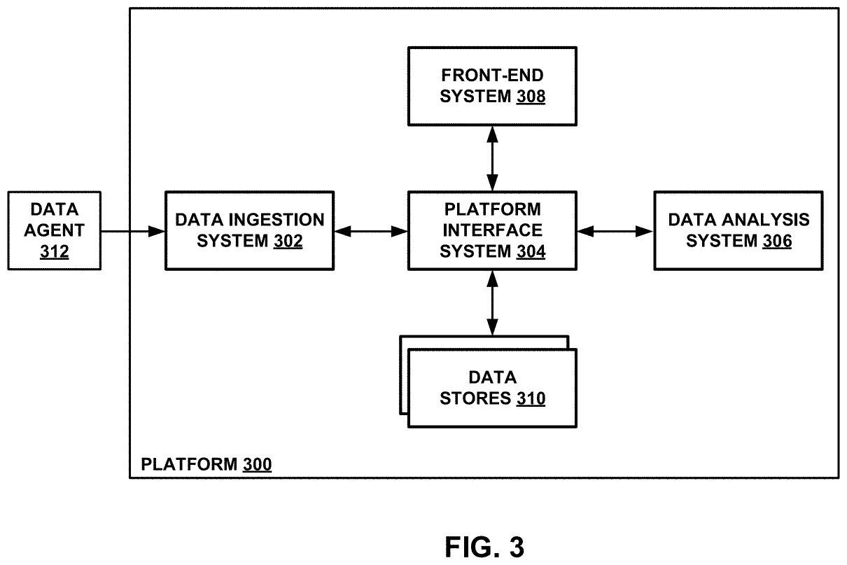

Referring now to FIG. 3, another simplified block diagram is provided to illustrate some functional systems that may be included in an example platform 300. For instance, as shown, the example platform 300 may include a data ingestion system 302, a platform interface system 304, a data analysis system 306, a front-end system 308, and one or more data stores 310, each of which comprises a combination of software and hardware that is configured to carry out particular functions. In line with the discussion above, these functional systems may be implemented on one or more computing systems, which may take the form of computing infrastructure of a public, private, and/or hybrid cloud or one or more dedicated servers, among other possibilities.

At a high level, data ingestion system 302 may be configured to ingest asset-related data received from the platform's one or more data sources, transform the ingested data into a standardized structure, and then pass the ingested data to platform interface system 304. In this respect, the function of ingesting received data may be referred to as the “extraction” (or “acquisition”) stage within data ingestion system 302, the function of transforming the ingested data into a desired structure may be referred to as the “transformation” stage within data ingestion system 302, and the function of passing the ingested data to platform interface system 304 may be referred to as the “load” stage within data ingestion system 302. (Alternatively, these functions may collectively be referred to as the ETL stage). In some embodiments, data ingestion system 302 may also be configured to enhance the ingested data before passing it to platform interface system 304. This function of enhancing the ingested data may be referred to as the “enhancement” stage within data ingestion system 302. However, data ingestion system 302 may take various other forms and perform various other functions as well.

At the extraction stage, data ingestion system 302 may be configured to receive and ingest various types of asset-related data from various types of data sources, including but not limited to the types of asset-related data and data sources 104 discussed above with reference to FIG. 1. Further, in line with the discussion above, data ingestion system 302 may be configured to receive asset-related data from a data source in various manners. For instance, one possibility, data ingestion system 302 may be configured to receive batch transmissions of asset-related data from a data source. As another possibility, data ingestion system 302 may be configured to receive asset-related data from a data source in a streaming fashion. As yet another possibility, data ingestion system 302 may be configured to receive asset-related data from a data source in response to sending a request for such data to the data source, in which case data ingestion system 302 may be configured to periodically send requests for asset-related data to the data source. As still another possibility, data ingestion system 302 may receive asset-related data from a data source by subscribing to a service provided by the data source (e.g., via an API or the like). Data ingestion system 302 may be configured to receive asset-related data from a data source in other manners as well.

Before data ingestion system 302 receives asset-related data from certain data sources, there may also be some configuration that needs to place at such data sources. For example, a data source may be configured to output the particular set of asset-related data that is of interest to platform 300. To assist with this process, the data source may be provisioned with a data agent 312, which generally comprises a software component that functions to access asset-related data at the given data source, place the data in the appropriate format, and then facilitate the transmission of that data to platform 300 for receipt by data ingestion system 302. In other cases, however, the data sources may be capable of accessing, formatting, and transmitting asset-related data to platform 300 without the assistance of a data agent.

Turning to the transformation phase, data ingestion system 302 may generally be configured to map and transform ingested data into one or more predefined data structures, referred to as “schemas,” in order to standardize the ingested data. As part of this transformation stage, data ingestion system 302 may also drop any data that cannot be mapped to a schema.

In general, a schema is an enforceable set of rules that define the manner in which data is to be structured in a given system, such as a data platform, a data store, etc. For example, a schema may define a data structure comprising an ordered set of data fields that each have a respective field identifier (e.g., a name) and a set of parameters related to the field's value (e.g., a data type, a unit of measure, etc.). In such an example, the ingested data may be thought of as a sequence of data records, where each respective data record includes a respective snapshot of values for the defined set of fields. The purpose of a schema is to define a clear contract between systems to help maintain data quality, which indicates the degree to which data is consistent and semantically correct.

In some implementations, data ingestion system 302 may also be configured to map and transform different types of asset-related data to different schemas. For instance, if the asset-related data received from different data sources is to be input into different types of data analytics operations that have different input formats, it may be advantageous to map and transform such asset-related data received from the different data sources to different schemas.

As part of the transformation stage, data ingestion system 302 may also be configured to perform various other quality checks on the asset-related data before passing it to platform interface system 304. For example, data ingestion system 302 may assess the reliability (or “health”) of certain ingested data and take certain actions based on this reliability, such as dropping any unreliable data. As another example, data ingestion system 302 may “de-dup” certain ingested data by comparing it against data that has already been received by platform 300 and then ignoring or dropping duplicative data. As yet another example, data ingestion system 302 may determine that certain ingested data is related to data already stored in the platform's data stores (e.g., a different version of the same data) and then merge the ingested data and stored data together into one data structure or record. Data ingestion system 302 may perform other types of quality checks as well.

It should also be understood that certain data ingested by data ingestion system 302 may not be transformed to a predefined schema (i.e., it is possible that certain ingested data will be “passed through” without performing any transformation on the data), in which case platform 300 may operate on this ingested data as it exists in its original data structure.

As noted above, in some embodiments, data ingestion system 302 may also include an “enhancement” stage where data ingestion system 302 enhances the ingested data before passing it to platform interface system 304. In this respect, data ingestion system 302 may enhance the ingested data in various manners. For instance, data ingestion system 302 may supplement the ingested data with additional asset-related data that is derived by and/or otherwise accessible to platform 300. Such additional data may take various forms. As one example, if the ingested data comprises sensor data, data ingestion system 302 may be configured to supplement the sensor data with “roll-up” data and/or “features” data that is derived from the sensor data. As another possible example, data ingestion system 302 may generate and append certain “enrichments” to the ingested data, examples of which are described in U.S. application Ser. No. 16/004,652, which is incorporated by reference herein in its entirety. Data ingestion system 302 may enhance the ingested data in other manners as well.

After data ingestion system 302 has performed any appropriate transformation and/or enhancement operations on the ingested data, it may pass the ingested data to platform interface system 304, which may be configured to receive data from data ingestion system 302, store the received data in one or more of data stores 310, and make the data available for consumption by the other functional systems of platform 300—including data analysis system 306 and/or front-end system 308. In this respect, the function of passing the ingested data from data ingestion system 302 to platform interface system 304 may take various forms.

According to an example implementation, data ingestion system 302 may begin by categorizing the ingested data into separate data categories (or “domains”) that are to be consumed separately by the platform's other functional systems. In turn, data ingestion system 302 may publish the data within each category to a corresponding interface (e.g., an API or the like) that is provided by platform interface system 304. However, it should be understood that other approaches for passing the ingested data from data ingestion system 302 to platform interface system 304 may be used as well, including the possibility that data ingestion system 302 may simply publish the ingested data to a given interface of platform interface system 304 without any prior categorization of the ingested data.

After platform interface system 304 receives the ingested data from data ingestion system 302, platform interface system 304 may cause that data to be stored at the appropriate data stores 310 within platform 300. For instance, in the event that platform interface system 304 is configured to receive different categories of ingested data, platform interface system 304 may be configured store data from a first category into a first data store 310, store data from a second category into a second data store 310, and so on. In addition, platform interface system 304 may store an archival copy of the ingested data into an archival data store 310. Platform interface system 304 may store the ingested data in other manners as well.

After receiving the ingested data from data ingestion system 302, platform interface system 304 may also make the ingested data available for consumption by the platform's other functional systems—including data analysis system 306 and front-end system 308. In this respect, platform interface system 304 may make the ingested data available for consumption in various manners, including through the use of message queues or the like.

After consuming data from platform interface system 304, data analysis system 306 may generally function to perform data analytics operations on such data and then pass the results of those data analytics operations back to platform interface system 304. These data analytics operations performed by data analysis system 306 may take various forms.

As one possibility, data analysis system 306 may create and/or execute predictive models related to asset operation based on asset-related data received from one or more data sources, such as predictive models that are configured to predict occurrences of failures at an asset. One example of a predictive model that may be created and executed by data analysis system 306 is described in U.S. application Ser. No. 14/732,258, which is incorporated by reference herein in its entirety.

As another possibility, data analysis system 306 may create and/or execute models for detecting anomalies in asset-related data received from one or more data sources. Some examples of anomaly detection models that may be created and executed by data analysis system 306 are described in U.S. application Ser. Nos. 15/367,012 and 15/788,622, which are incorporated by reference herein in their entirety.

As yet another possibility, data analysis system 306 may be configured to create and/or execute other types of data analytics programs based on asset-related data received from one or more data sources, examples of which include data analytics programs that evaluate asset-related data using a set of predefined rules (e.g., threshold-based rules), data analytics programs that generate predictive recommendations, data analytics programs that perform noise filtering, and data analytics programs that perform image analysis, among other possibilities.

The data analytics operations performed by data analysis system 306 may take various other forms as well.

Further, it should be understood that some of the data analytics operations discussed above may involve the use of machine learning techniques, examples of which may include regression, random forest, support vector machines (SVM), artificial neural networks, Naïve Bayes, decision trees, dimensionality reduction, k-nearest neighbor (kNN), gradient boosting, clustering, and association, among other possibilities.

As discussed above, after performing its data analytics operations, data analysis system 306 may then pass the results of those operations back to platform interface system 304, which may store the results in the appropriate data store 310 and make such results available for consumption by the platform's other functional systems—including data analysis system 306 and front-end system 308.

In turn, front-end system 308 may generally be configured to drive front-end applications that may be presented to a user via a client station (e.g., client station 106A). Such front-end applications may take various forms. For instance, as discussed above, some possible front-end applications for platform 300 may include an asset performance management application, an asset fleet management application, a service optimization application, and/or an asset dealer operations application, among other possibilities.

In practice, front-end system 308 may generally function to access certain asset-related data from platform interface system 304 that is to be presented to a user as part of a front-end application and then provide such data to the client station along with associated data and/or instructions that define the visual appearance of the front-end application. Additionally, front-end system 308 may function to receive user input that is related to the front-end applications for platform 300, such as user requests and/or user data. Additionally yet, front-end system 308 may support a software development kit (SDK) or the like that allows a user to create customized front-end applications for platform 300. Front-end system 308 may perform other functions as well.

Platform 300 may also include other functional systems that are not shown. For instance, although not shown, platform 300 may include one or more additional functional systems that are configured to output asset-related data and/or instructions for receipt by other output systems, such as third-party data platforms, assets, work-order systems, parts-ordering systems, or the like.

One of ordinary skill in the art will appreciate that the example platform shown in FIGS. 2-3 is but one example of a simplified representation of the structural components and/or functional systems that may be included in a platform, and that numerous others are also possible. For instance, other platforms may include structural components and/or functional systems not pictured and/or more or less of the pictured structural components and/or functional systems. Moreover, a given platform may include multiple, individual platforms that are operated in concert to perform the operations of the given platform. Other examples are also possible.

### III. EXAMPLE ASSET

As discussed above with reference to FIG. 1, asset data platform 102 may be configured to perform functions to facilitate the monitoring, analysis, and/or management of various types of assets, examples of which may include transport vehicles (e.g., locomotives, aircrafts, passenger vehicles, trucks, ships, etc.), equipment for construction, mining, farming, or the like (e.g., excavators, bulldozers, dump trucks, earth movers, etc.), manufacturing equipment (e.g., robotics devices, conveyor systems, and/or other assembly-line machines), electric power generation equipment (e.g., wind turbines, gas turbines, coal boilers), petroleum production equipment (e.g., gas compressors, distillation columns, pipelines), and data network nodes (e.g., personal computers, routers, bridges, gateways, switches, etc.), among other examples.

Broadly speaking, an asset may comprise a combination of one or more electrical, mechanical, electromechanical, and/or electronic components that are designed to perform one or more tasks. Depending on the type of asset, such components may take various forms. For instance, a transport vehicle may include an engine, a transmission, a drivetrain, a fuel system, a battery system, an exhaust system, a braking system, a generator, a gear box, a rotor, and/or hydraulic systems, which work together to carry out the tasks of a transport vehicle. However, other types of assets may include other various other types of components.

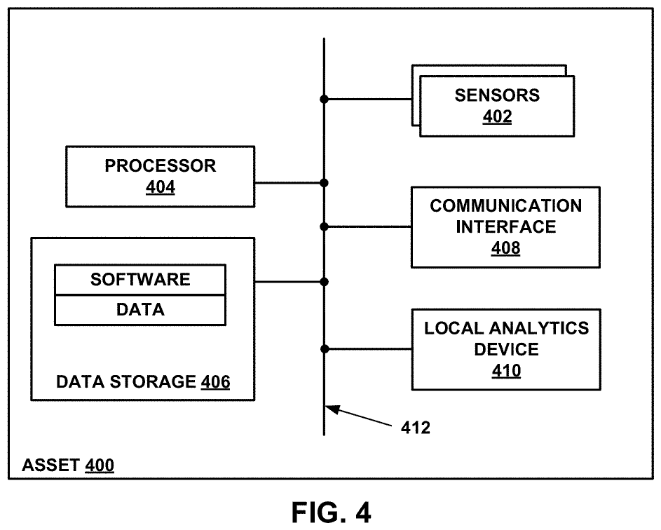

In addition to the aforementioned components, an asset may also be equipped with a set of on-board components that enable the asset to capture and report operating data. To illustrate, FIG. 4 is simplified block diagram showing some on-board components for capturing and reporting operating data that may be included within or otherwise affixed to an example asset 400. As shown, these on-board components may include sensors 402, a processor 404, data storage 406, a communication interface 408, and perhaps also a local analytics device 410, all of which may be communicatively coupled by a communication link 412 that may take the form of a system bus, a network, or other connection mechanism.

In general, sensors 402 may each be configured to measure the value of a respective operating parameter of asset 400 and then output data that indicates the measured value of the respective operating parameter over time. In this respect, the operating parameters of asset 400 that are measured by sensors 402 may vary depending on the type of asset, but some representative examples may include speed, velocity, acceleration, location, weight, temperature, pressure, friction, vibration, power usage, throttle position, fluid usage, fluid level, voltage, current, magnetic field, electric field, presence or absence of objects, current position of a component, and power generation, among many others.

In practice, sensors 402 may each be configured to measure the value of a respective operating parameter continuously, periodically (e.g., based on a sampling frequency), and/or in response to some triggering event. In this respect, each sensor 402 may have a respective set of operating parameters that defines how the sensor performs its measurements, which may differ on a sensor-by-sensor basis (e.g., some sensors may sample based on a first frequency, while other sensors sample based on a second, different frequency). Similarly, sensors 402 may each be configured to output data that indicates the measured value of its respective operating parameter continuously, periodically (e.g., based on a sampling frequency), and/or in response to some triggering event.

Based on the foregoing, it will be appreciated that sensors 402 may take various different forms depending on the type of asset, the type of operating parameter being measured, etc. For instance, in some cases, a sensor 402 may take the form of a general-purpose sensing device that has been programmed to measure a particular type of operating parameter. In other cases, a sensor 402 may take the form of a special-purpose sensing device that has been specifically designed to measure a particular type of operating parameter (e.g., a temperature sensor, a GPS receiver, etc.). In still other cases, a sensor 402 may take the form of a special-purpose device that is not primarily designed to operate as a sensor but nevertheless has the capability to measure the value of an operating parameter as well (e.g., an actuator). Sensors 402 may take other forms as well.

Processor 404 may comprise one or more processor components, such as general-purpose processors, special-purpose processors, programmable logic devices, controllers, and/or any other processor components now known or later developed. In turn, data storage 406 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc.

As shown in FIG. 4, data storage 406 may be arranged to contain executable program instructions (i.e., software) that cause asset 400 to perform various functions related to capturing and reporting operating data, along with associated data that enables asset 400 to perform these operations. For example, data storage 406 may contain executable program instructions that cause asset 400 to obtain sensor data from sensors 402 and then transmit that sensor data to another computing system (e.g., asset data platform 102). As another example, data storage 406 may contain executable program instructions that cause asset 400 to evaluate whether the sensor data output by sensors 402 is indicative of any abnormal conditions at asset 400 (e.g., by applying logic such as threshold-based rules to the measured values output by sensors 402), and then if so, to generate abnormal-condition data that indicates occurrences of abnormal conditions. The executable program instructions and associated data stored in data storage 406 may take various other forms as well.

Communication interface 408 may be configured to facilitate wireless and/or wired communication between asset 400 and various computing systems, including an asset data platform such as asset data platform 102. As such, communication interface 408 may take any suitable form for carrying out these functions, examples of which may include a chipset and antenna adapted to facilitate wireless communication, an Ethernet interface, a serial bus interface (e.g., Firewire, USB 2.0, etc.), and/or any other interface that provides for wireless and/or wired communication. Communication interface 408 may also include multiple communication interfaces of different types. Other configurations are possible as well. It should also be understood that asset 400 may not be equipped with its own on-board communication interface.

In some circumstances, it may also be desirable to perform certain data analytics operations locally at asset 400, rather than relying on a central platform to perform data analytics operations. Indeed, performing data analytics operations locally at asset 400 may reduce the need to transmit operating data to a centralized platform, which may reduce the cost and/or delay associated with performing data analytics operations at the central platform and potentially also increase the accuracy of certain data analytics operations, among other advantages.

In this respect, in some cases, the aforementioned on-board components of asset 400 (e.g., processor 404 and data storage 406) may provide sufficient computing power to locally perform data analytics operations at asset 400, in which case data storage 406 may be provisioned with executable program instructions and associated program data for performing the data analytics operations. However, in other cases, the aforementioned on-board components of asset 400 (e.g., processor 404 and/or data storage 406) may not provide sufficient computing power to locally perform certain data analytics operations at asset 400. In such cases, asset 400 may also optionally be equipped with local analytics device 410, which may comprise a computing device that is capable of performing data analytics operations and other complex operations that go beyond the capabilities of the asset's other on-board components. In this way, local analytics device 410 may generally serve to expand the on-board capabilities of asset 400.

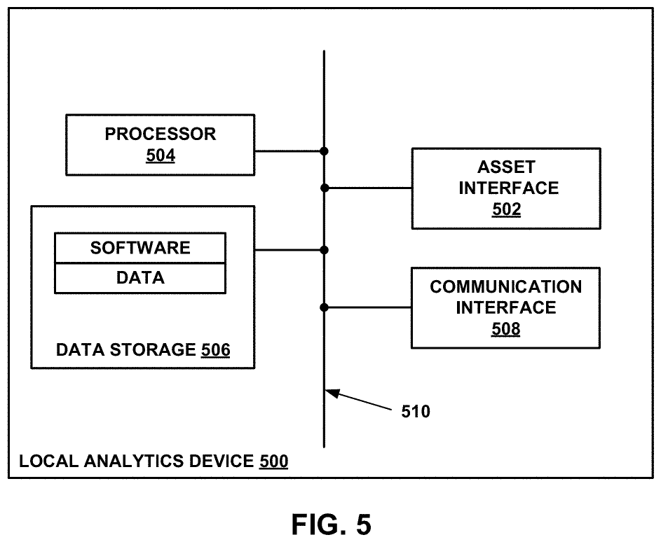

FIG. 5 illustrates a simplified block diagram showing some components that may be included in an example local analytics device 500. As shown, local analytics device 500 may include an asset interface 502, a processor 504, data storage 506, and a communication interface 508, all of which may be communicatively coupled by a communication link 510 that may take the form of a system bus, a network, or other connection mechanism.

Asset interface 502 may be configured to couple local analytics device 500 to the other on-board components of asset 400. For instance, asset interface 502 may couple local analytics device 500 to processor 404, which may enable local analytics device 500 to receive data from processor 404 (e.g., sensor data output by sensors 402) and to provide instructions to processor 404 (e.g., to control the operation of asset 400). In this way, local analytics device 500 may indirectly interface with and receive data from other on-board components of asset 400 via processor 404. Additionally or alternatively, asset interface 502 may directly couple local analytics device 500 to one or more sensors 402 of asset 400. Local analytics device 500 may interface with the other on-board components of asset 400 in other manners as well.

Processor 504 may comprise one or more processor components that enable local analytics device 500 to execute data analytics programs and/or other complex operations, which may take the form of general-purpose processors, special-purpose processors, programmable logic devices, controllers, and/or any other processor components now known or later developed. In turn, data storage 506 may comprise one or more non-transitory computer-readable storage mediums that enable local analytics device 500 to execute data analytics programs and/or other complex operations, examples of which may include volatile storage mediums such as random-access memory, registers, cache, etc. and non-volatile storage mediums such as read-only memory, a hard-disk drive, a solid-state drive, flash memory, an optical-storage device, etc.

As shown in FIG. 5, data storage 506 may be arranged to contain executable program instructions (i.e., software) that cause local analytics device 500 to perform data analytics operations and/or other complex operations that go beyond the capabilities of the asset's other on-board components, as well as associated data that enables local analytics device 500 to perform these operations.

Communication interface 508 may be configured to facilitate wireless and/or wired communication between local analytics device 500 and various computing systems, including an asset data platform such as asset data platform 102. In this respect, local analytics device 500 may communicate the results of its operations to an asset data platform via communication interface 508, rather than via an on-board communication interface of asset 400. Further, in circumstances where asset 400 is not be equipped with its own on-board communication interface, asset 400 may use communication interface 508 to transmit operating data to an asset data platform. As such, communication interface 508 may take any suitable form for carrying out these functions, examples of which may include a chipset and antenna adapted to facilitate wireless communication, an Ethernet interface, a serial bus interface (e.g., Firewire, USB 2.0, etc.), and/or any other interface that provides for wireless and/or wired communication. Communication interface 508 may also include multiple communication interfaces of different types. Other configurations are possible as well.

In addition to the foregoing, local analytics device 500 may also include other components that can be used to expand the on-board capabilities of an asset. For example, local analytics device 500 may optionally include one or more sensors that are configured to measure certain parameters, which may be used to supplement the sensor data captured by the asset's on-board sensors. Local analytics device 500 may include other types of components as well.

Returning to FIG. 4, although not shown, asset 400 may also be equipped with hardware and/or software components that enable asset 400 to adjust its operation based on asset-related data and/or instructions that are received at asset 400 (e.g., from asset data platform 102 and/or local analytics device 410). For instance, as one possibility, asset 400 may be equipped with one or more of an actuator, motor, value, solenoid, or the like, which may be configured to alter the physical operation of asset 400 in some manner based on commands received from processor 404. In this respect, data storage 406 may additionally be provisioned with executable program instructions that cause processor 404 to generate such commands based on asset-related data and/or instructions received via communication interface 408. Asset 400 may be capable of adjusting its operation in other manners as well.

Further, although not shown, asset 400 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with the on-board components of asset 400.

One of ordinary skill in the art will appreciate that FIGS. 4-5 merely shows one example of the components of an asset, and that numerous other examples are also possible. For instance, the components of an asset may include additional components not pictured, may have more or less of the pictured components, and/or the aforementioned components may be arranged and/or integrated in a different manner. Further, one of ordinary skill in the art will appreciate that two or more of the components of asset 400 may be integrated together in whole or in part. Further yet, one of ordinary skill in the art will appreciate that at least some of these components of asset 400 may be affixed or otherwise added to asset 400 after it has been placed into operation.

### IV. EXAMPLE OPERATIONS

As described above, the present disclosure is directed to a new predictive model for predicting an asset's fuel consumption based on several different categories of variables (referred to herein at times as a “fuel consumption model”), as well as an associated method for using the disclosed predictive model to evaluate the fuel efficiency of various different assets during various different observation periods and thereby identify the most likely causes for fuel inefficiency and/or the most impactful ways to improve fuel efficiency at the asset—which provides a direct financial benefit to an asset owner. In general, the disclosed predictive model may be defined and deployed by any computing system that has access to data described herein and has sufficient computing capability to perform data analytics operations, where such a computing system may generally be referred to herein as a “data analytics platform.”

For instance, as one possibility, the data analytics platform that defines and deploys the disclosed predictive model may take the form of a centralized asset data platform such as asset data platform 102 in FIG. 1. As another possibility, the data analytics platform that defines and deploys the disclosed predictive model may take the form of a local analytics device of an asset, such as asset 104A in FIG. 1. As yet another possibility, it is possible that the responsibility for carrying out the functions of defining and deploying the disclosed predictive model could be distributed across multiple data analytics platforms. The data analytics platform that defines and deploys the disclosed predictive model may take various other forms as well.

At a high level, the disclosed predictive model may be configured to predict a given asset's fuel consumption based on at least two of the following categories of data inputs related to the operation of the given asset during a given observation period (e.g., a particular window of time, a particular trip taken by the asset, etc.): (1) “asset-specific data,” which generally comprises data related to the configuration and/or physical condition of the given asset during the given observation period, (2) “operator-specific data,” which generally comprises data related to the individual that operated the given asset (e.g., the asset's driver) during the given observation period, and (3) “environmental data,” which generally comprises data related to the environment in which the given asset was operating during the given observation period.

The asset-specific data that may serve as input to the disclosed predictive model may take various forms. As one possibility, such asset-specific data may include data for one or more data variables related to the configuration of the given asset during the given observation period, examples of which may include asset type, asset make, asset model, and/or software version, among other possibilities. As another possibility, such asset-specific data may include data for one or more data variables related to the physical condition of the given asset during the given observation period (e.g., the asset's mechanical condition, electrical condition, etc.), examples of which may include sensor data variables and/or abnormal-condition data variables (e.g., fault codes), among other possibilities. As yet another possibility, such asset-specific data may include outputs of a predictive model that is related to the physical condition of the given asset, one example of which may take the form of a predictive model that is configured to predict occurrences of a given type of failure that has been recognized as being associated with fuel inefficiency (e.g., a predictive model for predicting occurrences of a Diesel Particulate Filter (DPF) at the given asset). The asset-specific data that may serve as input to the disclosed predictive model may take other forms as well, including the possibility that the asset-specific data may be derived by asset data platform 102 based on other data.

Further, the operator-specific data that may serve as input to the disclosed predictive model may take various forms. As one possibility, such operator-specific data may include data for one or more data variables that provide information about the operator of the given asset during the given observation period, examples of which may include data variables that provide identifying information for the operator and perhaps also data variables that reflect the operator's past handling of assets, among other possibilities. As another possibility, such operator-specific data may include data for one or more data variables that reflect the performance of the operator during the given observation period, examples of which may include data variables related to R.P.M, idling, breaking, and/or gear choice, among other possibilities. The operator-specific data that may serve as input to the disclosed predictive model may take other forms as well, including the possibility that the operator-specific data may be derived by asset data platform 102 based on other data (e.g., speed data, g-load data, idling events, breaking events, etc.).

Further yet, the environmental data that may serve as input to the disclosed predictive model may take various forms. As one possibility, such environmental data may include data for one or more data variables related to the environment in which the given asset was operating during the given observation period, examples of which may include one or more data variables identifying the type of road travelled (e.g., highway, rural roadway, metropolitan roadway, etc.) and/or one or more data variables related to traffic conditions (e.g., speed limit, traffic congestion level, etc.) of the route traveled, among other possibilities. As another possibility, such environmental data may include data for one or more data variables related to the weather associated with the environment in which the given asset was operating during the given observation period, examples of which may include data variables reflecting the precipitation level associated with the given asset's operating environment during the given observation period and/or the ambient weather conditions experienced by the given asset (e.g., temperature, pressure, humidity, etc.) during the given observation period, among other possibilities. The environmental data that may serve as input to the disclosed predictive model may take other forms as well, including the possibility that the environmental data may be derived by asset data platform 102 based on other data.

The disclosed predictive model may be configured to receive various other kinds of data inputs as well.

In practice, the disclosed predictive model may include any of various different combinations of variables from the data-variable categories described above as the model's input. For instance, in one implementation, the disclosed predictive model's input may comprise variables from all three categories described above (i.e., one or more asset-specific data variables, one or more operator-specific data variables, and one or more environmental data variables). In another implementation, the disclosed predictive model's input may comprise variables from two of three categories described above, as opposed to all three categories. Other implementations are possible as well. Further, it should be understood that the disclosed predictive model's input may comprise other data variables as well (e.g., data variables outside of the three categories described above).

As noted above, upon receiving data inputs from the above categories for a given asset during a given observation period, the disclosed predictive model may output a prediction of the given asset's fuel consumption during a given observation period. This output may take various forms. As one example, the output of the disclosed predictive model may comprise a predicted amount of fuel consumed by the given asset during the given observation period, either in total (e.g., predicted number of gallons consumed for an entire trip), per unit of time (e.g., predicted number of gallons consumed per hour), and/or per unit of distance (e.g., predicted number of gallons consumed per mile during a the given observation period. As another example, the output of the disclosed predictive model may comprise a predicted cost of fuel consumed by the given asset during the given observation period, either in total, per unit of time, and/or per unit of distance. The disclosed predictive model's output may take various other forms as well.

Further, in practice, the disclosed predictive model may be defined in various manners. In one implementation, the function of defining the disclosed predictive model may begin with the data analytics platform (e.g., asset data platform 102) obtaining a set of training data for use in training the disclosed predictive model. Asset data platform 102 perform this function in various manners.

As one possibility, asset data platform 102 may first obtain, for representative assets, historical fuel consumption data that indicates the amount of fuel actually consumed during each of a plurality of observation periods in the past. In this respect, the historical fuel consumption data for each observation period in the past may include an identification of the particular asset at issue, an indication of the timeframe spanned by the observation period at issue, and a measure of the amount of fuel that was actually consumed by the asset during the observation period, among other possibilities. In turn, asset data platform 102 may obtain, for a set of “candidate” data variables that could serve as input for the disclosed predictive model, historical data values that are associated with the observation periods in the past for which historical fuel consumption data has been obtained. For example, asset data platform 102 may obtain, for each of the plurality of observation periods in the past, a respective set of historical data values for asset-specific data variables, operator-specific data variables, and/or environmental data variables that could serve as input for the disclosed predictive model. Asset data platform 102 may then use the historical fuel consumption data and the corresponding historical data for set of “candidate” data variables as the set of training data for the disclosed predictive model.

However, asset data platform 102 may obtain the set of training data for use in training the disclosed predictive model in other manners as well.

In turn, asset data platform 102 may apply a machine learning technique to the obtained set of training data and thereby derive the disclosed predictive model. In this respect, there are various different machine learning techniques that could be applied by asset data platform 102 to derive the disclosed predictive model, examples of which may include regression, random forest, support vector machines (SVM), artificial neural networks, Naïve Bayes, decision trees, dimensionality reduction, k-nearest neighbor (kNN), gradient boosting, clustering, and association, among other possibilities.

As part of the process of defining the disclosed predictive model, asset data platform 102 may also validate the performance of the predictive model. This validation function may take various forms. As one possibility, asset data platform 102 may obtain a historical dataset associated with a given observation period in the past for which a measure of actual fuel consumption is available, input the historical dataset into the predictive model, and then compare the expected fuel consumption output by the predictive model for the given observation period to the actual fuel consumption. Asset data platform 102 may also carry out this function for a plurality of other historical datasets, and may then use the comparisons as a basis for determining whether the performance of the predictive model is sufficient to deploy the predictive model for use in evaluating asset fuel efficiency (e.g., whether the difference between the expected fuel consumption output by the predictive model and the actual fuel consumption is within an acceptable range of error). Asset data platform 102 may also validate the performance of the disclosed predictive model in other manners as well. Further, it should be understood that asset data platform 102 may also perform a validation function at various times after the predictive model has been deployed.

After the disclosed predictive model has been defined, the data analytics platform (e.g., asset data platform 102) may then use the predictive model carry out a process for evaluating the fuel efficiency of various different assets during various different observation periods.

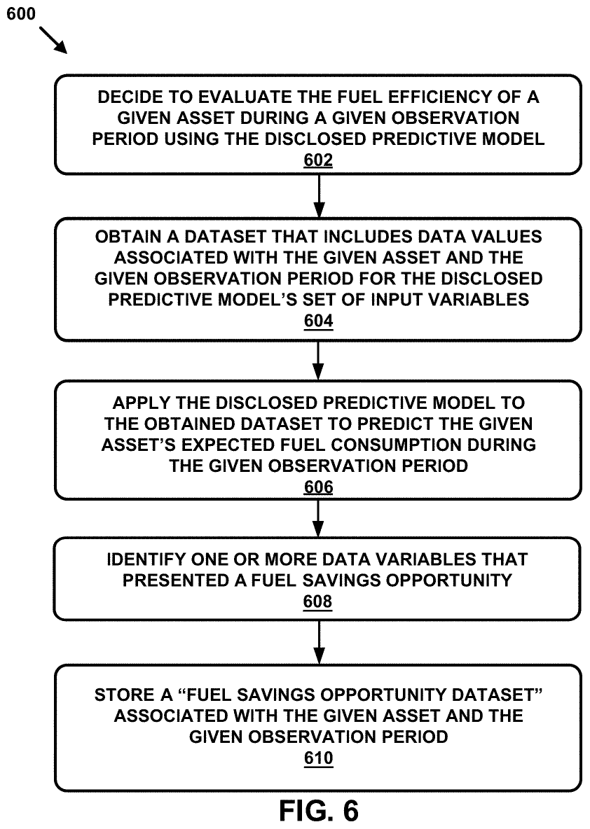

One possible example of this process will now be described with reference to a functional block diagram 600 shown in FIG. 6. For the purposes of illustration, the example operations are described as being carried out by asset data platform 102. However, it should be understood that data analytics platforms other than asset data platform 102 may perform the example operations. Likewise, it should be understood that the flow diagram in FIG. 6 is merely described in such manner for the sake of clarity and explanation and that some functions may be carried out in various other manners as well, including the possibility that example functions may be added, removed, rearranged into different orders, grouped together, and/or not grouped together at all.

As shown in FIG. 6, the disclosed process may involve: (1) at block 602, deciding to evaluate the fuel efficiency of a given asset during a given observation period using the disclosed predictive model; (2) at block 604, obtaining a dataset that includes data values associated with the given asset and the given observation period for the disclosed predictive model's set of input variables (e.g., one or more asset-specific, operator-specific, and/or environmental data variables); (3) at block 606, applying the disclosed predictive model to the obtained dataset in order to predict the given asset's expected fuel consumption during the given observation period; (4) at block 608, identifying one or more data variables that presented a fuel savings opportunity, and (5) at block 610, storing a “fuel savings opportunity dataset” associated with the given asset and the given observation period. As described herein, each of these functions may take various forms and may be carried out in various manners.

At block 602, asset data platform 102 may decide to evaluate the fuel efficiency of a given asset during a given observation period using the predictive model, which may occur at various times. For instance, as one possibility, asset data platform 102 may decide to evaluate the fuel efficiency of a given asset during a given observation period in response to detecting available input data related to the operation of the given asset during the given observation period. For example, asset data platform 102 may decide to evaluate the fuel efficiency of a given asset during a given observation period in response to detecting new asset-specific data, operator-specific data, and/or environmental data related to the operation of the given asset during the given observation period.

As another possibility, asset data platform 102 may decide to evaluate the fuel efficiency of a given asset during a given observation period in response to receiving an indication that a given type of failure is likely to occur at the given asset in the foreseeable future. For instance, in addition to running the disclosed predictive model for predicting an asset's fuel consumption, asset data platform 102 may also be configured to run failure models for predicting occurrences of failures of various types, and it has been recognized that some of these failure types may be associated with fuel inefficiency. For instance, one particular failure type that has been recognized as having an association with fuel inefficiency is a failure of a DPF, which is a filter designed to remove impure particles from an asset's engine. As such, asset data platform 102 may be configured to run a failure model for predicting occurrences of DPF failures and then use the output of this failure model as a basis for deciding whether to evaluate the fuel efficiency of a given asset during a given observation period using the disclosed predictive model. Asset data platform 102 may decide whether to evaluate the fuel efficiency of a given asset during a given observation period based on the output of other types of predictive models related to asset operation as well (e.g., other types of event occurrence models, anomaly detection models, etc.).

As yet another possibility, asset data platform 102 may decide to evaluate the fuel efficiency of assets in accordance with a schedule (e.g., daily, weekly, monthly, quarterly, etc.). In this respect, at a given scheduled evaluation time, asset data platform 102 may first determine the assets and observation periods for which new input data has become available, and asset data platform 102 may then evaluate the fuel efficiency of each such asset during each such observation period.

As a further possibility, asset data platform 102 may decide to evaluate the fuel efficiency of a given asset during a given observation period in response to receiving user input that may be entered via a client station (e.g., client station 104E), in which case asset data platform 102 may also be configured to provide a GUI through which a user may input a request to evaluate fuel efficiency of a given asset during a given observation period.

Asset data platform 102 may decide to evaluate the fuel efficiency of a given asset during a given observation period at various other times as well.

At block 604, after deciding to evaluate the fuel efficiency of a given asset during a given observation period, asset data platform 102 may obtain a dataset that includes data values associated with the given asset and the given observation period for the input data variables of the disclosed predictive model (e.g., one or more asset-specific, operator-specific, and/or environmental data variables). Asset data platform 102 may obtain the dataset in various manners and the one or more data values obtained for each input variable of the disclosed predictive model may take various forms.

As one possibility, a given input variable may have a value that is “static,” in the sense that the given input variable's value was not captured during the given observation period but rather was obtained by asset data platform 102 at an earlier time (e.g., during onboarding). For such an input variable, asset data platform 102 may obtain the last (and perhaps only) captured value of the given input variable and include that last-captured value in the dataset. Examples of data variables having static values such as this may include data variables related to the configuration of the given asset (e.g., a value corresponding to the given asset's type, make, model, etc.), among others.

As another possibility, a given input variable may have a value that is only captured once during the given observation period. For such an input variable, asset data platform 102 may obtain the one captured value of the given input variable from the given observation period and include that one capered value in the dataset. Examples of data variables having a value that is only captured once during the given observation period may include operator-specific data variables that provide identifying information for the operator, among others.

As yet another possibility, a given input variable may have a value that is captured multiple times during the given observation period. For such an input variable, asset data platform 102 may either include a vector of the given input variable's captured values in the dataset or may aggregate the given input variable's captured values into a single aggregated value (e.g., by taking the mean, median, etc. of the captured values) that is then included in the dataset. Examples of data variables having a value that is captured multiple times during the given observation period may include data variables related to the physical condition of the given asset (e.g., sensor data variables, abnormal-condition indicators, predictive model outputs, etc.), data variables reflecting the performance of the operator during the given observation period (e.g., R.P.M.), and data variables reflecting the ambient weather conditions experienced by the given asset during the given observation period, among others.

As still another possibility, a given input variable may have a value that is derived based on other underlying data captured during the given observation period. For such an input variable, asset data platform 102 may obtain the underlying data captured during the given observation period, derive the given input variable's value based on the obtained data, and then include that derived value in the dataset. Examples of data variables having a value that is derived based on other underlying data captured during the given observation period may include a data variable reflecting the total amount of idling time during a given observation period (which may be derived based on underlying data regarding idling events), a data variable reflecting the total number of breaking events during a given observation period (which may be derived based on underlying data regarding breaking events), a data variable reflecting the total precipitation level associated with the environment in which the given asset operated during the given observation period (which may be derived based on underlying data regarding precipitation in the operating environment during the given observation period), and a data variable indicating whether or not a given asset experienced any abnormal conditions of a given type during the given observation period (which may be derived based on abnormal-condition indicators captured during the given observation period), among others.

Asset data platform 102 may obtain the dataset in various other manners and the one or more data values obtained for each input variable of the disclosed predictive model may take various other forms as well.

Further, asset data platform 102 may obtain the dataset from various sources. For example, asset data platform 102 may obtain the dataset from one or more datastores that maintain such data values, which may be stored at asset data platform 102 and/or some other data source that is accessible to asset data platform 102. Asset data platform 102 may obtain the dataset from various other sources as well.

At block 606, after obtaining the dataset that includes data values associated with the given asset and the given observation period for the input data variables of the disclosed predictive model, asset data platform 102 may then apply the disclosed predictive model to the obtained dataset in order to predict the given asset's expected fuel consumption during the given observation period. In this respect, the disclosed predictive model may accept the obtained dataset that comprises asset-specific data, operator-specific data, and/or environmental data that i related to the operation of the given asset during the given observation period as input and then output a value that indicates the given asset's expected fuel consumption during the given observation period, which may take any of the forms discussed above.

In turn, at block 608, asset data platform 102 may identify one or more data variables that presented a fuel savings opportunity. This function may take various forms.

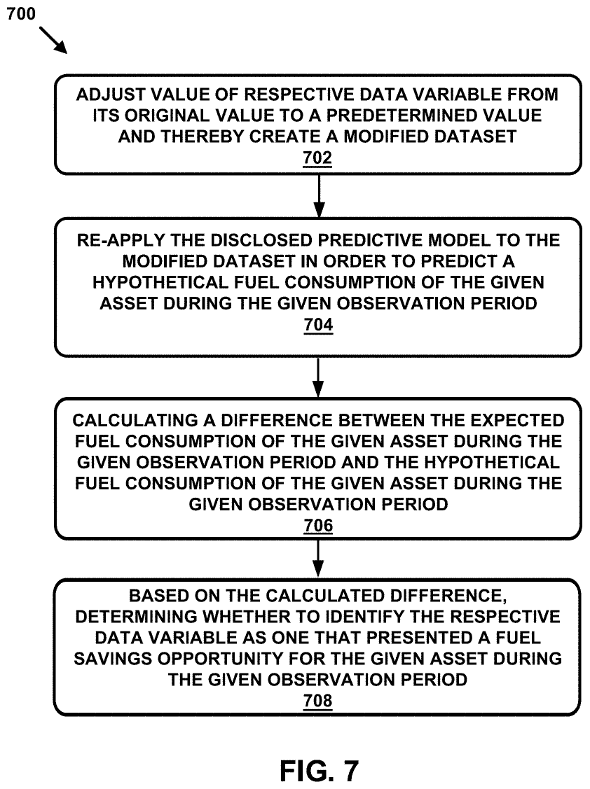

As one possible implementation, asset data platform 102 may identify one or more data variables that presented a fuel savings opportunity using an iterative process involving each data variable of a plurality of the data variables included in the obtained dataset. One example of this iterative process will now be described with reference to a functional block diagram 700 shown in FIG. 7.

For the purposes of illustration, it should be understood that the flow diagram in FIG. 7 is merely described in such manner for the sake of clarity and explanation and that some functions may be carried out in various other manners as well, including the possibility that example functions may be added, removed, rearranged into different orders, grouped together, and/or not grouped together at all.

As shown in FIG. 7, the iterative process may involve: for each respective data variable of the plurality of data variables included in the obtained dataset (1) at block 702, adjusting the value of the respective data variable from its original value to a predetermined value that is intended to represent a “normal” value for the respective data variable (while keeping the values for all other data variables the same) and thereby creating a modified dataset; (2) at block 704, re-applying the disclosed predictive model to the modified dataset comprising the adjusted value of the representative data variable in order to predict a hypothetical fuel consumption of the given asset during the given observation period; (3) at block 706, calculating a difference between the expected fuel consumption of the given asset during the given observation period and the hypothetical fuel consumption of the given asset during the given observation period; and (4) at block 708, based on the calculated difference, determining whether to identify the respective data variable as one that presented a fuel savings opportunity for the given asset during the given observation period. As described herein, each of these functions may take various forms and may be carried out in various manners.

At block 702, asset data platform 102 may adjust the value of a respective data variable from its original value to a predetermined value that is intended to represent a “normal” value for the respective data variable (while keeping the values for all other data variables the same), and thereby create a modified dataset. The predetermined value that is intended to represent a “normal” value may be determined in various manners.

In one implementation, the predetermined value that is intended to represent a “normal” value may be determined based on an evaluation of historical data values of the data variable for representative assets during a plurality of observation periods in the past, where representative assets may generally comprise assets that share one or more similar characteristics with the given asset (e.g., make, model, etc.). In this respect, the function of determining a “normal” value of a data variable based on an evaluation of historical data values for the data variable may take various forms, which may depend on the nature of the data variable and its value. As one possible example, asset data platform 102 may determine a “normal” value of a data variable based on an evaluation of historical data values for the data variable by organizing the historical data values into a distribution and then selecting a value that corresponds to a given point along the distribution. As another possible example, asset data platform 102 may determine a “normal” value of a data variable based on an evaluation of historical data values for the data variable by identifying the most common value of the data variable and then using that value as the “normal” value.” The predetermined value that is intended to represent a normal value may be determined in various other manners as well—including the possibility that the value may be determined based on user input.

Further, the function of adjusting the data value of a respective data variable from its original value to a predetermined value that is intended to represent a normal value for the respective data variable (while keeping the values for all other data variables the same) may take various forms, which may depend in part on the nature of the data variable and its value. Some representative examples of adjusting the data value of a data variable from its original value to a predetermined value that is intended to represent a normal value for the data variable are described below.

As one possibility, asset data platform 102 may adjust a value of a data variable related to the configuration of the given asset from its original value to a predetermined value that reflects an asset configuration considered to be associated with “normal” fuel efficiency. For example, asset data platform 102 may adjust a value of a data variable reflecting the model of the given asset during the given observation period, which may provide insight as to whether fuel efficiency can be improved by employing different asset models. As another example, asset data platform 102 may adjust a value of a data variable reflecting the software version of the given asset during the given observation period, which may provide insight as to whether fuel efficiency can be improved by employing a different software version at the asset. Other examples are possible as well.

As another possibility, asset data platform 102 may adjust a value of a data variable related to the physical condition of the given asset during the given observation period from its original value to a predetermined value that reflects a physical condition of the given asset considered to be associated with “normal” fuel efficiency. For example, asset data platform 102 may adjust a value of a sensor data variable for the given asset from its measured value (or perhaps multiple measured values) to a “normal” value and/or may adjust a value of an abnormal-condition indictor from a captured value of “true” (or perhaps multiple captured values of “true”) to a value of “false,” which may provide insight as to whether fuel efficiency can be improved by improving the physical condition of the given asset. Other examples are possible as well.

As yet another possibility, asset data platform 102 may adjust a value of a data variable that provides identifying information for the operator of the given asset during the given observation period from its original value to a predetermined value that identifies an operator considered to be associated with “normal” fuel efficiency, which may provide insight as to whether fuel efficiency can be improved by changing operators.

As still another possibility, asset data platform 102 may adjust a value of a data variable that reflects the performance of the operator of the given asset during the given observation period from its original value to a predetermined value that reflects operator performance considered to be associated with “normal” fuel efficiency. For example, asset data platform 102 may adjust a value of an idling time variable from its captured value to a “normal” value, which may provide insight as to whether fuel efficiency can be improved by reducing idling time. As another example, asset data platform 102 may adjust a value of a breaking-event variable from its captured value to a “normal” value, which may provide insight as to whether fuel efficiency can be improved by reducing the number of breaking events. Other examples are possible as well.

As a further possibility, asset data platform 102 may adjust a value of a data variable that reflects ambient weather conditions during the given observation period from its original value to a predetermined value that reflects ambient weather conditions considered to be associated with “normal” fuel efficiency. For example, asset data platform 102 may adjust a value of an ambient temperature variable from its measured value (or perhaps multiple measured values) to a “normal” value, which may provide insight as to whether fuel efficiency can be improved by operating an asset in locations and/or at times that are associated with different temperature conditions. Other examples are possible as well.

Asset data platform 102 may adjust a data value of a respective data variable from its original value to a predetermined value that is intended to represent a normal value for the respective data variable (while keeping the values for all other data variables the same) in various other manners as well.

The decision of which data variables to include in the plurality of data variables that have their values adjusted may also take various forms. In one implementation, the plurality of data variables that have their values adjusted may be defined to include any input data variable with a value that can be influenced at least in part by some action taken by an asset owner or operator, while the plurality of data variables may be defined to exclude any input data variable with a value that cannot be influenced by some action taken by an asset owner or operator. For instance, it is typically possible for an asset owner or operator to influence the values of data variables related to some aspects of an asset's configuration (e.g., brand, model, software version, etc.), data variables related to the physical condition of an asset, data variables related to the identity or performance of an asset operator, and/or data variables related to certain aspects of an asset's operating environment, in which case such data variables may be included in the plurality of data variables that have their values adjusted and evaluated using the predictive model. On the other hand, it may be difficult (or impossible) for an asset owner or operator to influence the values of data variables related to other aspects of an asset's configuration (e.g., type, make, etc.) and/or data variables related to other aspects of an asset's operating environment (e.g., ambient weather conditions, unless it is possible to change the timing and location of the asset's operation), among other possibilities, in which case such data variables may be excluded from the plurality of data variables that have their values adjusted and evaluated using the predictive model.

However, in other implementations, the plurality of data variables that have their values adjusted may still include certain input data variables with values that cannot be influenced by user action. In such an implementation, asset data platform 102 may be capable of identifying such data variables as ones that are negatively impacting fuel efficiency and may then present such data variables along with the other identified fuel savings opportunities, but such data variables may not be associated with a fuel savings opportunity that is actionable.

The decision of which data variables to include in the plurality of data variables that have their values adjusted may be based on other factors as well, including but not limited to user input specifying which data variables are of particular interest to an asset owner or operator.

At block 704, after adjusting the value of a respective data variable from its original value to a predetermined value that is intended to represent a “normal” value for the respective data variable (while keeping the values for all other data variables the same) and thereby creating a modified dataset, asset data platform 102 may re-apply the disclosed predictive model to the modified dataset comprising the adjusted value of the respective data variable (and values of all other data variables that were kept the same), which may involve the disclosed predictive model (1) accepting the adjusted value of the respective data variable along with values of all the other data variables that were kept the same, and then (2) predicting a hypothetical fuel consumption of the given asset during the given observation period. The function of re-applying the disclosed predictive model to the modified dataset may take various forms.

As one example to illustrate, after adjusting the total idling time of the given asset associated during the given observation period from its original value to a “normal” value (while keeping the values for all other data variables the same), asset data platform 102 may re-apply the disclosed predictive model to the modified dataset comprising the adjusted value of the total idling time and thereby predict a hypothetical fuel consumption of the given asset during the given observation period, which may differ from the expected fuel consumption of the given asset during the given observation period. Many other examples are possible as well.

At block 706, asset data platform 102 may calculate a difference between the expected fuel consumption of the given asset during the given observation period and the hypothetical fuel consumption of the given asset during the given observation period in various manners.

As one example to illustrate, if the expected fuel consumption of the given asset is 30 gallons and the hypothetical fuel consumption of the given asset fuel is 16 gallons when a given data variable is adjusted to its “normal” value, asset data platform 102 may then calculate the difference between the expected fuel consumption and the hypothetical fuel consumption to be equal to 14 gallons, which represents a predicted amount of fuel savings opportunity associated with the given data variable. As another example to illustrate, the expected fuel consumption of the given asset is 30 gallons and the hypothetical fuel consumption of the given asset fuel is 29 gallons when a given data variable is adjusted to its “normal” value, asset data platform 102 may then calculate the difference between the expected fuel consumption and the hypothetical fuel consumption to be equal to 1 gallon, which represents a predicted amount of fuel savings opportunity associated with the given data variable. Many other examples are possible as well.

Asset data platform 102 may calculate a difference between the expected fuel consumption of the given asset during the given observation period and the hypothetical fuel consumption of the given asset during the given observation period in various other manners as well.

At block 708, based on the calculated difference, asset data platform 102 may then determine whether to identify the respective data variable as one that presented a fuel savings opportunity in various manners. For instance, in one implementation, if the calculated difference between the expected fuel consumption of the given asset and the hypothetical fuel consumption of the given asset is positive (i.e., greater than 0), such a calculated difference may indicate that the respective data variable presented a fuel savings opportunity. Further, as noted above, the calculated amount of difference may serve as a predicted amount of fuel savings opportunity associated with the respective data variable. On the other hand, if the calculated difference between the two values is not positive (i.e., 0 or negative), such a calculated difference may indicate that the respective data variable does not present a fuel savings opportunity.

In another implementation, asset data platform 102 may determine whether to identify the respective data variable as one that presented a fuel savings opportunity by comparing the calculated difference between the two values to a threshold value, which may either be a global threshold that is applicable to all types of fuel savings opportunities or may be a specific threshold that is associated with the given type of fuel savings opportunity being evaluated.

To illustrate with an example, if the threshold value is 5 gallons, then asset data platform may identify a data variable as presenting a fuel savings opportunity when the calculated difference between the expected fuel consumption of the given asset and the hypothetical fuel consumption of the given asset exceeds 5 gallons and may not identify the data variable as presenting a fuel savings opportunity when the calculated difference between the expected fuel consumption of the given asset and the hypothetical fuel consumption of the given asset is below 5 gallons.

Asset data platform 102 may determine whether to identify the respective data variable as one that presented a fuel savings opportunity in various other manners as well.

As mentioned above, asset data platform 102 may repeat the foregoing iterative process for at least a subset of the remaining data variables in the obtained dataset in order to identify data variables that presented a fuel savings opportunity.

In some implementations, after identifying the one or more data variables that presented a fuel savings opportunity and determining the corresponding amount of fuel savings opportunity for each such data variable, asset data platform 102 may also optionally group the identified data variables into one or more categories of fuel savings opportunities. For example, if the data variables identified by asset data platform 102 include two or more variables related to the mechanical operation of the given asset (e.g., two or more sensor data variables), asset data platform 102 may group the two or more variables related to the mechanical operation into a single fuel savings opportunity referred to as “mechanicals” fuel savings opportunity, which may involve summing the respective amount of fuel savings opportunity for each such data variable into a single, aggregated amount of the “mechanicals” fuel savings opportunity. Asset data platform 102 may group the identified data variables into one or more categories of fuel savings opportunities in other manners as well.

In other implementations, after identifying the one or more data variables that presented a fuel savings opportunity and determining the corresponding amount of fuel savings opportunity for each such data variable, asset data platform 102 may also optionally determine whether there is any other identifiable factor that presented a fuel savings opportunity for the given asset during the given observation period, and if so, the amount of fuel saving opportunity presented by that other identifiable factor. Such a determination may take various forms.

As one possibility, as discussed above, asset data platform 102 may be configured to evaluate fuel efficiency of the given asset during the given observation period in response to detecting an indication that a given type of failure is likely to occur at the given asset in the foreseeable future, such as a DPF filter. According to such a configuration, asset data platform 102 may detect that a given type of failure is likely to occur at the given asset in the foreseeable future and then responsively evaluates fuel efficiency of the given asset during the given observation period as discussed above, which may result in asset data platform 102 identifying one or more data variables that presented a fuel savings opportunity and determining the corresponding amount of fuel savings opportunity for each such data variable. In turn, asset data platform 102 may be configured to determine an amount of fuel savings opportunity that is attributable to the predicted failure at the given asset. Asset data platform 102 may determine this amount in various manners.

As one possibility, asset data platform 102 may determine an amount of savings opportunity that is attributable to a predicted failure of a given type based on an analysis of historical data, such as a comparison between (a) historical fuel consumption data for observation periods where no failure of the given type was predicted and (b) historical fuel consumption data for observation periods where at least one failure of the given type was predicted. For example, based on such an analysis, asset data platform 102 may determine that a prediction of a DPF failure during an observation period typically leads to a 5% increase in fuel consumption, and asset data platform 102 may then use this information to determine the amount of savings opportunity that is attributable to a predicted DPF failure during the given observation period.

As another possibility, asset data platform 102 may determine an amount of savings opportunity that is attributable to a predicted failure of a given type by (a) summing up the respective amount of fuel savings opportunity presented by each of the identified one or more variables into an aggregated amount of fuel savings opportunity that was collectively presented by the identified one or more variables for given asset during the given observation period, (b) determining a total amount of fuel savings opportunity that should have been available for given asset during the given observation period, (c) calculating a difference between the total amount of fuel savings opportunity that should have been available and the aggregated amount of fuel savings opportunity that was collectively presented by the identified one or more variables, and (d) designate the calculated difference as an amount of fuel savings opportunity that can be achieved by addressing the source of the predicted failure occurrence (e.g., by replacing the asset's DPF).

Asset data platform 102 may determine an amount of fuel savings opportunity that is attributable to a predicted failure at the given asset in various other manners as well. For instance, in line with discussion above, the output of a predictive failure model may also be included as one of the inputs of the disclosed predictive model, in which case the amount of fuel savings opportunity that is attributable to a failure predicted by such a predictive failure model may be determined using the process described above (e.g., by adjusting the value of predictive failure model's output to a “normal” value and then evaluating how that impacts the fuel consumption output by the disclosed predictive model). Other implementations are possible as well.

Asset data platform 102 may determine whether there is any other identifiable factor that presented a fuel savings opportunity for the given asset during the given observation period (and if so, the amount of fuel saving opportunity presented by that other identifiable factor) in various other manners as well.

At block 610, asset data platform 102 may then store a “fuel savings opportunity dataset” associated with the given asset and the given observation period, where a given fuel savings opportunity dataset may comprise the identified one or more data variables that presented a fuel savings opportunity and a respective predicted fuel savings amount for each of the identified one or more variables. For instance, a fuel savings opportunity dataset may include an identified data variable related to idling that occurred at the given asset during the given observation period that presented a fuel savings opportunity, and the respective predicted fuel savings amount (e.g., 14 gallons) for the identified data variable. The fuel savings opportunity dataset may also include other identified data variables that presented a fuel savings opportunity and respective predicted fuel savings amounts for those identified variables.

In practice, it may be the case that the stored fuel savings opportunity dataset only includes a subset of the identified one or more variables as opposed to all of the identified one or more variables, such as a subset that only includes the identified one or more data variables presenting the largest fuel savings opportunities for the given asset during the given observation period. For instance, if there is a set of 5 data variables identified that presented a fuel savings opportunity, each having a corresponding value that indicates a predicted amount of such opportunity, asset data platform 102 may store a fuel savings dataset that includes only the “top 2” data variables in this set in terms of the amount of fuel savings opportunity presented by such variables, or asset data platform 102 may store a fuel savings dataset that includes only the data variables in this set having a corresponding amount of fuel savings opportunity that exceeds a threshold value, among other possibilities. However, one of ordinary skill in the art will appreciate that the stored fuel savings opportunity dataset may include a different subset or all of the identified one or more variables that presented a fuel savings opportunity associated with the given asset and the given observation period.

In accordance with the present disclosure, the disclosed process described above with reference to FIG. 6 may be repeated to derive fuel savings opportunity datasets for various different assets during various different observations periods. Further, after the disclosed process has been repeated for various different assets during various different observations periods, a data analytics platform (e.g., asset data platform 102) may roll up the resulting fuel savings opportunity datasets in various manners.

As one possibility, such fuel savings opportunity datasets may be rolled up across all assets in a fleet and all different observation periods that have been evaluated, which may produce a single rolled-up dataset for the fleet of assets that indicates the top one or more fuel savings opportunities for the fleet and perhaps also an indication of the predicted amount of each such fuel savings opportunity (which may comprise an aggregation across the different assets and observation periods).

As another possibility, such fuel savings opportunity datasets may be broken out on an asset-by-asset basis and then each respective asset's fuel savings opportunity datasets may be rolled up across all observation periods that have been evaluated for the respective asset, which may produce a rolled-up dataset for each respective asset that indicates the top one or more fuel savings opportunities for the respective asset and perhaps also an indication of the predicted amount of each such fuel savings opportunity (which may comprise an aggregation across the different observation periods for the asset).

As yet another possibility, such fuel savings opportunity datasets may be broken out on an operator-by-operator basis and then the fuel savings opportunity datasets for each respective operator may be rolled up across all observation periods that have been evaluated for the respective operator, which may produce a rolled-up dataset for each respective operator that indicates the top one or more fuel savings opportunities for the respective operator and perhaps also an indication of the predicted amount of each such fuel savings opportunity (which may comprise an aggregation across the different observation periods for the operator).

The fuel savings opportunity datasets may be rolled up in various other manners as well.

Further yet, the individual and/or rolled up fuel savings opportunity datasets may be used to help a user (e.g., an asset owner and/or operator) visualize fuel savings opportunities and/or fuel inefficiencies (e.g., the most likely causes for fuel inefficiency at a given asset, the most impactful ways to improve fuel efficiency at a given asset, etc.). In this respect, a data analytics platform (e.g., asset data platform 102) may be configured to provide a GUI through which the individual and/or rolled-up fuel savings opportunity datasets may be presented, where such a GUI may be accessed by a user via a client station (e.g., client station 104E) that is communicatively coupled to the data analytics platform. The provided GUI may take various forms.

In one implementation, the GUI may comprise a “fleet level” view that helps the user visualize the overall fuel savings opportunities for a given fleet. In this respect, the fleet level view may comprise various information.

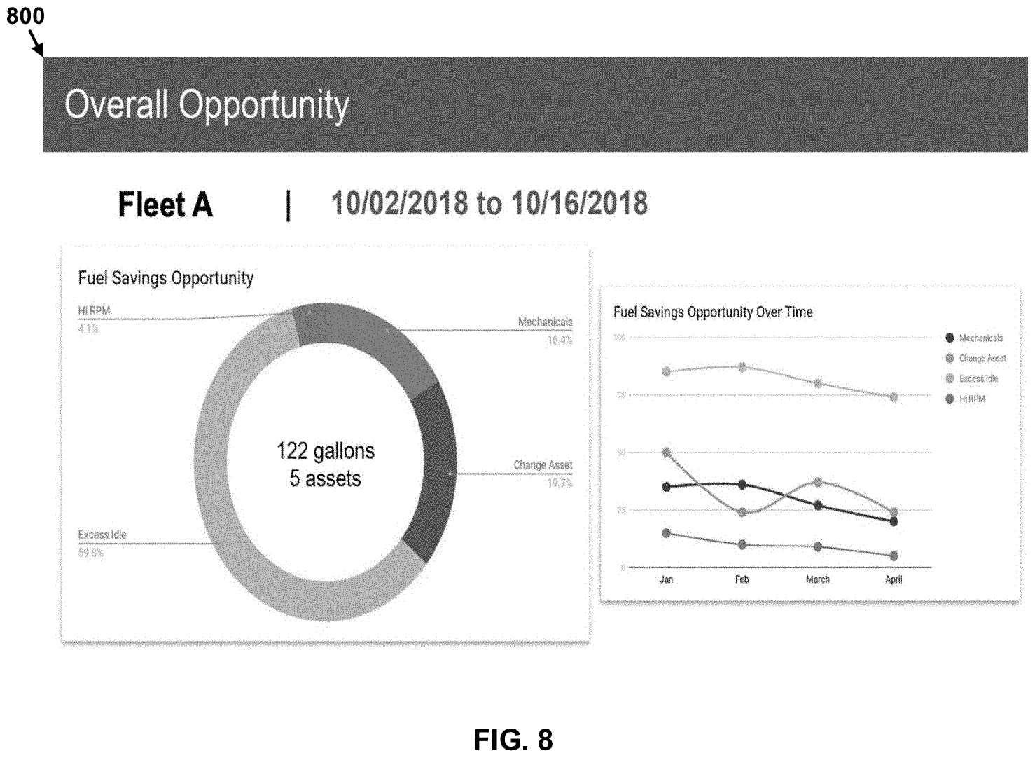

As one example to illustrate, FIG. 8 depicts an example fleet level view 800 that may be provided to a client station (e.g., client station 104E) that is communicatively coupled to a data analytics platform (e.g., asset data platform 102). As shown, fleet-level view 800 may include various information. For example, fleet-level view 800 may include information identifying a given fleet, such as a fleet name (e.g., “Fleet A”), a fleet ID (not shown), a fleet location (not shown), and the number of assets in the given fleet (“5 assets”), among other possibilities. As another example, fleet-level view 800 may include the aggregate amount of fuel savings opportunity for the given fleet (“122 gallons”) during a given timeframe of interest (e.g., “10/02/2018 to 10/16/2018”).

As yet another example, fleet-level view 800 may show a set of “top” fuel savings opportunities for the given fleet, which may be determined using the process described above. For instance, as shown, fleet-level view 800 may identify an “Excess Idle” fuel savings opportunity that is associated with a data variable related to idling time, a “HI RPM” fuel savings opportunity that is associated with a data variable related to R.P.M, a “Mechanicals” fuel savings opportunity that is associated with one or more data variables related to mechanical condition, and a “Change Asset” fuel savings opportunity that is associated with one or more data variables related to asset configuration.

As still another example, fleet-level view 800 may show a representative amount of fuel savings that is presented by each of the identified fuel savings opportunities for the given fleet during a given timeframe of interest, either in total or as a percentage of the aggregate amount of fuel savings that are presented by the set of “top” fuel savings opportunities, among other possibilities.

The fleet-level view may comprise various other information as well.

In another implementation, the GUI may comprise an “asset level” view that helps a user visualize a respective amount of fuel savings presented by a particular type of fuel savings opportunity for each asset in the given fleet. For example, for each asset in the given fleet, the asset-level view may include a respective amount of fuel savings presented by an “Excess Idle” fuel savings opportunity, perhaps along some other relevant information for the assets such as a respective amount of idle time that occurred at each asset during a given timeframe of interest and/or a respective number of idling events that occurred at each asset during a given timeframe of interest, among other possibilities. The asset-level view may comprise various other information as well.

In still another implementation, the GUI may comprise an “operator level” view that helps a user visualize the amount of fuel savings opportunities associated with a given asset operator during a given timeframe of interest. For example, the operator-level view may include identifying information for a given asset operator, such as operator ID, along with a respective amount of fuel savings opportunity that was available during each of a plurality of observation periods associated with the operator (e.g., trips taken by the given operator). The operator-level view may comprise various other information as well.

One of ordinary skill in the art will appreciate that information included in the GUI may be expressed in various manners (e.g., graph, table, text, etc.) and may be arranged in various manners. In this respect, the GUI may take various other forms as well.

Further, the data analytics platform may roll up the resulting fuel savings opportunity datasets in various other manners as well.

Once the individual and/or rolled-up fuel savings opportunity datasets have been provided to a user (e.g., an asset owner and/or operator), the user may then create a tailored action plan for how to best improve the fuel efficiency of its assets, which may involve addressing certain aspects of assets in a given fleet that are believed to have a negative impact on aspects of asset operation and/or coaching individual operators of the assets in a given fleet to address certain operator events that are believed to have a negative impact on aspects of asset operation.

### VI. CONCLUSION

Example embodiments of the disclosed innovations have been described above. Those skilled in the art will understand, however, that changes and modifications may be made to the embodiments described without departing from the true scope and sprit of the present invention, which will be defined by the claims.

Further, to the extent that examples described herein involve operations performed or initiated by actors, such as “humans”, “operators”, “users” or other entities, this is for purposes of example and explanation only. The claims should not be construed as requiring action by such actors unless explicitly recited in the claim language.

What is claimed is:

1. A computing system comprising:
a communication interface;
at least one processor;
a non-transitory computer-readable medium; and
program instructions stored on the non-transitory computer-readable medium that are executable by the at least one processor to cause the computing system to:
define a predictive model that is configured to (i) receive, for a given set of data variables, data values that are related to operation of an asset during an observation period, and (ii) based on the received data values, output a prediction of fuel consumption of the asset during the observation period, wherein the given set of data variables includes data variables from at least two different categories of data variables selected from a group consisting of an asset-specific data variable category, an operator-specific data variable category, and an environmental data variable category;
obtain a dataset that includes, for the given set of data variables, data values that are related to operation of a given asset during a given observation period;
apply the predictive model to the obtained dataset and thereby predict an expected fuel consumption of the given asset during the given observation period;
perform an evaluation of whether any data variable in the given set of data variables presented a fuel savings opportunity for the given asset during the given observation period, wherein the evaluation comprises, for each respective data variable in at least a subset of the given set of data variables:
modifying the dataset to include, for the respective data variable, a different data value that is associated with normal operation;
re-applying the predictive model to the modified dataset and thereby predicting a hypothetical fuel consumption of the given asset during the given observation period;
performing a comparison between the expected fuel consumption of the given asset during the given observation period and the hypothetical fuel consumption of the given asset during the given observation period; and
based on the comparison, determining whether the respective data variable presented a fuel savings opportunity for the given asset during the given observation period; and
based on the evaluation, identify one or more data variables that presented a fuel savings opportunity for the given asset during the given observation period.

2. The computing system of claim 1, further comprising program instructions stored on the non-transitory computer-readable medium that are executable by the at least one processor to cause the computing system to:
store a fuel savings opportunity dataset related to the operation of the given asset during the given observation period that includes (i) an indication of the identified one or more data variables that presented the fuel savings opportunity and (ii) for each of the identified one or more variables, a corresponding amount of the fuel savings opportunity that is presented.

3. The computing system of claim 1, wherein:
performing the comparison between the expected fuel consumption of the given asset during the given observation period and the hypothetical fuel consumption of the given asset during the given observation period comprises calculating a difference between the expected fuel consumption of the given asset during the given observation period and the hypothetical fuel consumption of the given asset during the given observation period; and
determining whether the respective data variable presented a fuel savings opportunity comprises (i) if the calculated difference exceeds a threshold, determining that the respective data variable did present a fuel savings opportunity, or (ii) if the calculated difference does not exceed the threshold, determining that the respective data variable did not present a fuel savings opportunity.

4. The computing system of claim 3, wherein the threshold is either (i) zero or (ii) a value greater than zero.

5. The computing system of claim 3, wherein the evaluation further comprises:
if the calculated difference exceeds the threshold, using the calculated difference as a basis for determining a predicted amount of fuel savings opportunity presented by the respective data variable for the given asset during the given observation period.

6. The computing system of claim 1, wherein the given set of data variables includes at least one data variable from the asset-specific data variable category that comprises an output of a predictive model related to asset operation.

7. The computing system of claim 1, further comprising program instructions stored on the non-transitory computer-readable medium that are executable by the at least one processor to cause the computing system to:
before obtaining the dataset and applying the predictive model to the obtained dataset, predict an occurrence of a given type of failure at the given asset; and
wherein the program instructions that are stored on the non-transitory computer-readable medium that are executable by the at least one processor to cause the computing system to obtain the dataset and apply the predictive model to the obtained dataset comprise program instructions stored on the non-transitory computer-readable medium that are executable by the at least one processor to cause the computing system to obtain the dataset and apply the predictive model to the obtained dataset in response to predicting the occurrence of the given type of failure at the given asset.

8. The computing system of claim 1, further comprising program instructions stored on the non-transitory computer-readable medium that are executable by the at least one processor to cause the computing system to:
use the identified one or more variables as a basis for generating a visualization related to fuel savings opportunities; and
cause a client station to display the visualization.

9. A method performed by a computing system, the method comprising:
defining a predictive model that is configured to (i) receive, for a given set of data variables, data values that are related to operation of an asset during an observation period, and (ii) based on the received data values, output a prediction of fuel consumption of the asset during the observation period, wherein the given set of data variables includes data variables from at least two different categories of data variables selected from a group consisting of an asset-specific data variable category, an operator-specific data variable category, and an environmental data variable category;
obtaining a dataset that includes, for the given set of data variables, data values that are related to operation of a given asset during a given observation period;
applying the predictive model to the obtained dataset and thereby predict an expected fuel consumption of the given asset during the given observation period;
performing an evaluation of whether any data variable in the given set of data variables presented a fuel savings opportunity for the given asset during the given observation period, wherein the evaluation comprises, for each respective data variable in at least a subset of the given set of data variables:
modifying the dataset to include, for the respective data variable, a different data value that is associated with normal operation;
re-applying the predictive model to the modified dataset and thereby predicting a hypothetical fuel consumption of the given asset during the given observation period;
performing a comparison between the expected fuel consumption of the given asset during the given observation period and the hypothetical fuel consumption of the given asset during the given observation period; and
based on the comparison, determining whether the respective data variable presented a fuel savings opportunity for the given asset during the given observation period; and
based on the evaluation, identifying one or more data variables that presented a fuel savings opportunity for the given asset during the given observation period.

10. The method of claim 9, further comprising:
storing a fuel savings opportunity dataset related to the operation of the given asset during the given observation period that includes (i) an indication of the identified one or more data variables that presented the fuel savings opportunity and (ii) for each of the identified one or more variables, a corresponding amount of the fuel savings opportunity that is presented.

11. The method of claim 9, wherein:
performing the comparison between the expected fuel consumption of the given asset during the given observation period and the hypothetical fuel consumption of the given asset during the given observation period comprises calculating a difference between the expected fuel consumption of the given asset during the given observation period and the hypothetical fuel consumption of the given asset during the given observation period; and
determining whether the respective data variable presented a fuel savings opportunity comprises (i) if the calculated difference exceeds a threshold, determining that the respective data variable did present a fuel savings opportunity, or (ii) if the calculated difference does not exceed the threshold, determining that the respective data variable did not present a fuel savings opportunity.

12. The method of claim 11, wherein the threshold is either (i) zero or (ii) a value greater than zero.

13. The method of claim 11, wherein the evaluation further comprises:
if the calculated difference exceeds the threshold, using the calculated difference as a basis for determining a predicted amount of fuel savings opportunity presented by the respective data variable for the given asset during the given observation period.

14. The method of claim 9, wherein the given set of data variables includes at least one data variable from the asset-specific data variable category that comprises an output of a predictive model related to asset operation.

15. The method of claim 9, further comprising:
before obtaining the dataset and applying the predictive model to the obtained dataset, predicting an occurrence of a given type of failure at the given asset; and
wherein obtaining the dataset and applying the predictive model to the obtained dataset comprise obtaining the dataset and applying the predictive model to the obtained dataset in response to predicting the occurrence of the given type of failure at the given asset.

16. The method claim 9, further comprising:
using the identified one or more variables as a basis for generating a visualization related to fuel savings opportunities; and
causing a client station to display the visualization.

17. A non-transitory computer-readable storage medium having program instructions stored thereon that are executable to cause a computing system to:
define a predictive model that is configured to (i) receive, for a given set of data variables, data values that are related to operation of an asset during an observation period, and (ii) based on the received data values, output a prediction of fuel consumption of the asset during the observation period, wherein the given set of data variables includes data variables from at least two different categories of data variables selected from a group consisting of an asset-specific data variable category, an operator-specific data variable category, and an environmental data variable category;
obtain a dataset that includes, for the given set of data variables, data values that are related to operation of a given asset during a given observation period;
apply the predictive model to the obtained dataset and thereby predict an expected fuel consumption of the given asset during the given observation period;
perform an evaluation of whether any data variable in the given set of data variables presented a fuel savings opportunity for the given asset during the given observation period, wherein the evaluation comprises, for each respective data variable in at least a subset of the given set of data variables:
modifying the dataset to include, for the respective data variable, a different data value that is associated with normal operation;
re-applying the predictive model to the modified dataset and thereby predicting a hypothetical fuel consumption of the given asset during the given observation period;
performing a comparison between the expected fuel consumption of the given asset during the given observation period and the hypothetical fuel consumption of the given asset during the given observation period; and
based on the comparison, determining whether the respective data variable presented a fuel savings opportunity for the given asset during the given observation period; and
based on the evaluation, identify one or more data variables that presented a fuel savings opportunity for the given asset during the given observation period.

18. The non-transitory computer-readable storage medium of claim 17, further comprising program instructions stored thereon that are executable to cause the computing system to:
store a fuel savings opportunity dataset related to the operation of the given asset during the given observation period that includes (i) an indication of the identified one or more data variables that presented the fuel savings opportunity and (ii) for each of the identified one or more variables, a corresponding amount of the fuel savings opportunity that is presented.

19. The non-transitory computer-readable storage medium of claim 17, wherein:
performing the comparison between the expected fuel consumption of the given asset during the given observation period and the hypothetical fuel consumption of the given asset during the given observation period comprises calculating a difference between the expected fuel consumption of the given asset during the given observation period and the hypothetical fuel consumption of the given asset during the given observation period; and
determining whether the respective data variable presented a fuel savings opportunity comprises (i) if the calculated difference exceeds a threshold, determining that the respective data variable did present a fuel savings opportunity, or (ii) if the calculated difference does not exceed the threshold, determining that the respective data variable did not present a fuel savings opportunity.

20. The non-transitory computer-readable storage medium of claim 17, wherein the threshold is either (i) zero or (ii) a value greater than zero.
